(19) United States
(12) Patent Application Publication
(10) Pub. No.: US 2023/0102962 A1
(43) Pub. Date: Mar. 30, 2023

(54) MICROPOROUS MEMBRANES, BATTERY SEPARATORS, COATED SEPARATORS, BATTERIES, AND RELATED METHODS

(71) Applicant: Celgard, LLC, Charlotte, NC (US)

(72) Inventors: Barry J. Summey, Lake Wylie, SC (US); Takahiko Kondo, Shiga (JP); William John Mason, McConnells, SC (US); Kang Karen Xiao, Mississauga (CA); Robert Moran, Concord, NC (US); Jeffrey G. Poley, Indian Land, SC (US); Brian R. Stepp, Scotttsdale, AZ (US); Kristoffer K. Stokes, Lunenburg, MA (US); Xiaomin Zhang, Charlotte, NC (US)

(21) Appl. No.: 17/982,276

(22) Filed: Nov. 7, 2022

Related U.S. Application Data
(63) Continuation of application No. 16/616,521, filed on Nov. 25, 2019.
(60) Provisional application No. 62/511,465, filed on May 26, 2017.

(51) Int. Cl. B01D 67/00; H01M 50/491; H01M 50/406; H01M 50/417; B29C 55/12; H01M 50/463; H01M 50/494; B01D 69/02; H01M 50/451; B01D 69/12; H01M 50/446; H01M 50/403; H01M 50/449; B01D 71/26; H01M 10/0525; H01M 50/457; B29C 48/00; B29K 23/00; B29L 31/34; B29L 31/00

(52) U.S. Cl. CPC B01D 67/0027; H01M 50/491; H01M 50/406; H01M 50/417; B01D 67/0088; B29C 55/12; H01M 50/463; H01M 50/494; B01D 69/02; H01M 50/451; B01D 69/12; H01M 50/446; H01M 50/403; H01M 50/449; B01D 71/26; H01M 10/0525; H01M 50/457; B29C 48/0018; B29K 2023/12; B29K 2023/04; B01D 2325/24; B29L 2031/3468; B01D 2325/04; B29L 2031/755

(57) ABSTRACT

This application is directed to new and/or improved MD and/or TD stretched and optionally calendered membranes, separators, base films, microporous membranes, battery separators including said separator, base film or membrane, batteries including said separator, and/or methods for making and/or using such membranes, separators, base films, microporous membranes, battery separators and/or batteries. For example, new and/or improved methods for making microporous membranes, and battery separators including the same, that have a better balance of desirable properties than prior microporous membranes and battery separators. The methods disclosed herein comprise the following steps: 1.) obtaining a non-porous membrane precursor; 2.) forming a porous biaxially-stretched membrane precursor from the non-porous membrane precursor; 3.) performing at least one of (a) calendering, (b) an additional machine direction (MD) stretching, (c) an additional transverse direction (TD) stretching, and (d) a pore-filling on the porous biaxially stretched precursor to form the final microporous membrane. The microporous membranes or battery separators described herein may have the following desirable balance of properties, prior to application of any coating: a TD tensile strength greater than 200 or 250 kg/cm², a puncture strength greater than 200, 250, 300, or 400 gf, and a JIS Gurley greater than 20 or 50 s.

### CROSS REFERENCE TO RELATED APPLICATIONS

### Priority Claim

This application is a Continuation Application which claims priority to U.S. application Ser. No. 16/616,521, filed Nov. 25, 2019, which claims priority to PCT Application No. PCT/US2018/034335, May 24, 2018, which claims priority to U.S. Provisional Patent Application No. 62/511,465, which was filed on May 26, 2017 and is hereby incorporated by reference herein in its entirety.

### FIELD

This application is directed to new and/or improved microporous membranes, battery separators including said microporous membranes, and/or methods for making new and/or improved microporous membranes and/or battery separators including such microporous membranes. For example, the new and/or improved microporous membranes, and battery separators including such membranes, may have better performance, unique structure, and/or a better balance of desirable properties than prior microporous membranes. Also, the new and/or improved methods produce microporous membranes, thin porous membranes, unique membranes, and/or battery separators including such membranes, having a better performance, unique performance, unique performance for dry process membranes or separators, unique structure, and/or a better balance of desirable properties than prior microporous membranes. The new and/or improved microporous membranes, battery separators including said microporous membranes, and/or methods may address issues, problems, or needs associated with at least certain prior microporous membranes.

### BACKGROUND

As technological demands increase, demands on battery separator performance, quality, and manufacture also increase. Various techniques and methods have been developed to improve the performance properties of microporous membranes used as battery separators in, for example, lithium ion batteries, including modern rechargeable or secondary lithium ion batteries.

However, while prior techniques and methods have been capable of achieving improved performance in some areas, this has often come at the price of sacrificing (sometimes large sacrifices) performance in another area. For example, prior methods and techniques for forming microporous membranes capable of being used as battery separators employed only machine direction (MD) stretching, e.g., to create pores and increase MD tensile strength. However, certain microporous membranes made by these methods had low transverse direction (TD) tensile strength.

To improve TD tensile strength, we added a TD stretching step. TD stretching improved TD tensile strength and reduced splittiness of a microporous membrane compared to, for example, a microporous membrane that is not subjected to TD stretching and has only been subjected to machine direction MD stretching. Thickness of the microporous membrane may also be reduced with the addition of TD stretching, which is desirable. However, TD stretching was found to also result in decreased JIS Gurley, increased porosity, decreased wettability, reduced uniformity, and/or in decreased puncture strength, of at least certain of the TD stretched membranes. Hence there is a need for at least certain applications for improved membranes, separators, and/or microporous membranes having a better balance of the above-mentioned properties without any decrease or reduction in performance.

### SUMMARY

In accordance with at least selected embodiments, the present application or invention may address the above-mentioned issues, problems or needs of prior membranes, separators, and/or microporous membranes, and/or may provide new and/or improved membranes, separators, microporous membranes, battery separators including said microporous membranes, coated separators, base films for coating, and/or methods for making and/or using new and/or improved microporous membranes and/or battery separators including such microporous membranes. For example, the new and/or improved microporous membranes, and battery separators including such membranes, may have better performance, unique structure, and/or a better balance of desirable properties than prior microporous membranes. Also, the new and/or improved methods produce microporous membranes, thin porous membranes, unique membranes, and/or battery separators including such membranes, having a better performance, unique performance, unique performance for dry process membranes or separators, unique structure, and/or a better balance of desirable properties than prior microporous membranes. The new and/or improved microporous membranes, battery separators including said microporous membranes, and/or methods may address issues, problems, or needs associated with at least certain prior microporous membranes.

In accordance with at least selected embodiments, the present application or invention may address the above-mentioned issues, problems or needs of prior microporous membranes or separators, and/or may provide new and/or improved microporous membranes, battery separators including said microporous membranes, and/or methods for making new and/or improved microporous membranes and/or battery separators including such microporous membranes. For example, the new and/or improved microporous membranes, and battery separators including such membranes, may have better performance, unique structure, and/or a better balance of desirable properties than prior microporous membranes. Also, the new and/or improved methods produce microporous membranes, and battery separators including such membranes, having a better performance, unique structure, and/or a better balance of desirable properties than prior microporous membranes. The new and/or improved microporous membranes, battery separators including said microporous membranes, and/or methods may address issues, problems, or needs associated with at least certain prior microporous membranes, and may be useful in batteries and/or capacitors. In at least certain aspects or embodiments, there may be provided unique, improved, better, or stronger dry process membrane products, such as but not limited to unique stretched and/or calendered products having a puncture strength (PS) of >200, >250, >300, or >400 gf, preferably when normalized for thickness and porosity and/or at 14 μm or less, 12 um or less thickness, more preferably at 10 um or less thickness, a unique pore structure of angled, aligned, oval (for example, in cross-section view SEM), or more polymer, plastic or meat (for example, in surface view SEM), unique characteristics, specs, or performance of porosity, uniformity (std dev), transverse direction (TD) strength, shrinkage (machine direction (MD) or TD), TD stretch %, MD/TD balance, MD/TD tensile strength balance, tortuosity, and/or thickness, unique structures (such as coated, pore filled, monolayer, and/or multi-layer), unique methods, methods of production or use, and combinations thereof.

In at least one aspect or embodiment, the present inventive methods, microporous membranes, and/or separators described herein achieve a better balance of desired properties, and still at least meet (if not exceed) the minimum requirements for lithium battery separators.

In at least selected possibly preferred embodiments, a method for forming a microporous membrane, e.g., a membrane comprising micropores, is disclosed, which comprises, consists of, or consists essentially of forming or obtaining a non-porous precursor material (typically an extruded and blown or cast sheet, film, tube, parison, or bubble) and simultaneously or sequentially stretching the non-porous precursor material in a machine direction (MD) and/or in a transverse direction (TD), which is perpendicular to the MD, to form a porous biaxially-stretched precursor membrane. The porous biaxially stretched precursor membrane is then further subjected to at least one of (a) calendering, (b) additional MD stretching, (c) additional TD stretching, (d) pore filling, and (e) coating. In some embodiments, the porous biaxially stretched precursor is subjected to calendering or calendering and pore-filling, in that order. In other embodiments, the porous biaxially-stretched precursor is subjected to additional MD stretching, additional TD stretching, calendering, pore-filling, and coating, in that order, additional MD stretching, calendering, and pore-filling, in that order, additional MD stretching and pore-filling, in that order, etc. In some embodiments, the porous biaxially-stretched precursor is subjected to additional MD-stretching and additional TD stretching, in that order, additional TD stretching only, additional TD-stretching and pore-filling, in that order, additional TD-stretching, calendering, and coating or pore-filling, in that order, etc.

In at least certain embodiments, a method for forming a microporous membrane, e.g., a membrane comprising micropores, is disclosed, which comprises, consists of, or consists essentially of forming or obtaining a non-porous precursor material (typically a sheet, film, tube, parison, or bubble) and then stretching the non-porous precursor material in a machine direction (MD) and/or in a transverse direction (TD) to form a porous biaxially-stretched precursor membrane. The porous MD and/or TD stretched precursor membrane is then further subjected to at least one of (a) calendering, (b) additional MD stretching, (c) additional TD stretching, (d) pore-filling, and (e) coating.

In at least particular certain embodiments, a method for forming a microporous membrane, e.g., a membrane comprising micropores, is disclosed, which comprises, consists of, or consists essentially of forming or obtaining a non-porous precursor material (typically a sheet, film, tube, parison, or bubble) and then stretching the non-porous precursor material in a machine direction (MD) and/or in a transverse direction (TD) with MD relax to form a porous biaxially-stretched precursor membrane. The porous MD and/or TD stretched precursor membrane is then further subjected to at least one of (a) calendering, (b) additional MD stretching without relax, (c) additional TD stretching, (d) pore-filling, and (e) coating.

In embodiments where the non-porous precursor membrane is sequentially machine direction (MD) stretched and transverse direction (TD) stretched to form the porous biaxially-stretched precursor, first the nonporous precursor material or layer is MD stretched to form a porous uniaxially MD stretched precursor porous membrane and then the porous uniaxially stretched precursor is stretched in the transverse direction (TD) to form a porous biaxially stretched precursor membrane. In some embodiments, at least one of an MD relaxation step and a TD relaxation step is performed before, during, or after the MD stretching of the non-porous precursor membrane or before, during, or after the TD stretching of the uniaxially stretched precursor membrane. It may be preferred, that at least a portion of the TD stretching be conducted with at least some MD relax. This is especially helpful when TD stretching a previously MD stretched dry process polymer membrane.

In embodiments where the nonporous precursor material is simultaneously machine direction (MD) and transverse direction (TD) stretched to form the porous biaxially stretched precursor membrane, at least one of machine direction (MD) relaxation and transverse direction (TD) relaxation is performed during or after the simultaneous MD and TD stretching of the nonporous precursor material.

The stretching may include cold stretching and/or hot stretching of the precursor material or membrane. It may be preferred to have a first cold stretching step, followed by at least one hot stretching step.

In some embodiments, the nonporous precursor material (sheet, film, tube, parison, or bubble) is formed by extrusion of at least one polyolefin, including polyethylene (PE) and polypropylene (PP). The nonporous precursor material or membrane may be a monolayer or a multilayer, i.e., 2 or more layers, nonporous precursor. In preferred embodiments, the extruded or cast nonporous precursor is a monolayer comprising at least one or PE or PP or the nonporous membrane is a trilayer having a PP-containing layer, a PE-containing layer, and a PP-containing layer, in that order, or having a PE-containing layer, a PP-containing layer, and a PE-containing layer, in that order.

In some embodiments, the nonporous precursor membrane is annealed before any stretching is performed, e.g., before initial and/or additional machine direction (MD) stretching or transverse (TD) direction stretching.

In some embodiments, a battery separator comprises, consists of, or consists essentially of a microporous membrane made according to a method for forming a porous membrane as described hereinabove. In some embodiments the microporous membrane is coated on one or two-sides (both sides) when it is used in or as a battery separator. For example, in some embodiments, the microporous membrane is coated on one or two sides with a ceramic coating comprising at least one polymeric binder and at least one of organic and inorganic particles.

In another aspect, a battery separator comprising, consisting of, or consisting essentially of at least one porous membrane having each of the following properties is described herein: a TD tensile strength greater than 200 or greater than 250 kg/cm², a puncture strength greater than 200, 250, 300, or 400 gf, and a JIS Gurley greater than 20 or 50 seconds (s). The porous membrane preferably has these properties prior to application of any coating, e.g., a ceramic coating, which could increase and/or decrease any one of these properties. In some preferred embodiments, the JIS Gurley is between 20 and 300 s or 50 and 300 s, the puncture strength is between 300 and 600 gf, and the TD tensile strength is between 250 and 400 kg/cm². The porous membrane may have a thickness between 4 and 30 microns, and may be a monolayer or multilayer, e.g., 2 or more layers, porous membrane. In one preferred embodiment, the porous membrane is a trilayer comprising a polyethylene (PE)-containing layer, a polypropylene (PP)-containing layer, and a PE-containing layer, in that order (PE-PP-PE), or a PP-containing layer, a PE-containing layer, and a PP-containing layer, in that order (PP-PE-PP). In another possibly preferred embodiment, the porous membrane is a monolayer, multilayer, bilayer or trilayer dry process MD and/or TD stretched and optionally calendered polymer membrane, film or sheet comprising one or more polyolefin layers, membranes or sheets, such as a polyethylene (PE)-containing layer, a polypropylene (PP)-containing layer, PE and PP-containing layers, or combinations of PP and PE-containing layers, such as PP, PE, PP/PP, PE/PE, PP/PP/PP, PE/PE/PE, PP/PP/PE, PE/PE/PP, PP/PE/PP, PE/PP/PE, PE-PP, PE-PP/PE-PP, PP/PP-PE, PE/PP-PE, etc.

One possible multilayer membrane that may be MD and/or TD stretched and optionally calendered is a multilayer coextruded microlayer and laminated sublayer construction described in PCT publication WO2017/083633A1, published May 18, 2017, hereby fully incorporated by reference herein. Such constructions may combine multiple co-extruded sublayers (each having a plurality of microlayers) via lamination to achieve unique properties for dry process separator membranes.

### BRIEF DESCRIPTION OF THE DRAWINGS

FIG. 1 is a schematic diagram of certain methods or embodiments for forming a microporous membrane as described herein from a non-porous membrane precursor.

FIG. 2 is three respective SEM surface images of the exemplary pore structure (or lack thereof) for a nonporous membrane precursor (substantially nonporous), a porous uniaxially-stretched membrane precursor, and a porous biaxially stretched membrane or precursor. In FIG. 2, the white double-arrowed lines indicate the MD direction.

FIG. 3 is a reference schematic enlarged diagram labeling the different pails of the micropore structures of the microporous membranes described herein.

FIG. 4 is a surface SEM image showing exemplary pore structure of a microporous membrane that has been MD stretched, TD stretched, and then calendered. In FIG. 4, the white double-arrowed line indicates the MD direction.

FIG. 5 is a schematic reference example of separator shutdown performance.

FIG. 6 is a very schematic cross-section or layer representation of a one-side coated (OSC) membrane or separator and a two-side coated (TSC) membrane or separator according to OSC or TSC battery separator embodiments. The membranes may be single or multiple layer membranes. The coatings may be the same on each side or different (such as ceramic coating on both sides, PVDF on both sides, or ceramic coating on one side and PVDF coating on the other side).

FIG. 7 is a schematic reference illustration of a lithium-ion battery according to at least some embodiments herein.

FIG. 8 and FIG. 9 are respective sets of SEMs of the MD stretched porous PP/PE/PP trilayer precursor, the TD stretched porous PP/PE/PP trilayer membrane (MD+TD stretched), and finally, the calendered stretched porous PP/PE/PP trilayer membrane or separator (MD+TD+calendered). The SEM images also include some thickness, JIS Gurley and porosity data, for certain of the materials or membranes. FIG. 9 includes information on whether the SEM is a surface SEM or a cross-section SEM.

FIG. 10 is a graphical representation of puncture strength/thickness vs MD+TD strength that shows that HMW Calendered MD and TD stretched PP/PE/PP trilayer performs better than conventional dry process product, e.g., conventional MD-only PP/PE/PP trilayer, and as well as a comparative wet process product without requiring the use of solvent and oils as required by a wet process.

FIG. 11 is a graphical representation of membrane properties for respective samples following TD stretching at 4.5× (450%), different samples were subjected to an additional MD stretching of 0.06, 0.125, and 0.25%. The TD tensile strength, puncture strength, JIS Gurley, and thickness of the MD-stretched PP/PE/PP trilayer nonporous precursor, the MD and TD stretched PP/PE/PP trilayer nonporous precursor, and the MD and TD (with additional MD stretching at 0.06, 0.125, and 0.25%) were measured and are reported in the graph.

### DETAILED DESCRIPTION

In accordance with at least selected embodiments, aspects or objects, the present application or invention may address the problems, issues or needs of the prior technology, and/or is directed to or provides new and/or improved membranes, separators, microporous membranes, base films or membranes to be coated, battery separators including said membranes, separators, microporous membranes, and/or base films, and/or methods for making new and/or improved microporous membranes and/or battery separators including such microporous membranes. For example, the new and/or improved microporous membranes, and battery separators including such membranes, may have better performance, unique structure, and/or a better balance of desirable properties than prior microporous membranes. Also, the new and/or improved methods produce microporous membranes, thin porous membranes, unique membranes, and/or battery separators including such membranes, having a better performance, unique performance, unique performance for dry process membranes or separators, unique structure, and/or a better balance of desirable properties than prior microporous membranes. The new and/or improved microporous membranes, battery separators including said microporous membranes, and/or methods may address issues, problems, or needs associated with at least certain prior microporous membranes.

Commonly owned, co-pending, U.S. Published Patent Application Pub. No.: US 2017/0084898 A1 published Mar. 23, 2017 is hereby fully incorporated by reference herein.

In accordance with at least selected embodiments, aspects or objects, the present application or invention may address the problems, issues or needs of the prior technology, and/or is directed to or provides new and/or improved microporous membranes, battery separators including said microporous membranes, and methods for making new and/or improved microporous membranes and/or battery separators comprising said microporous membranes. For example, the new and/or improved MD and/or TD stretched and optionally calendered microporous membranes, and battery separators comprising the same, may have better performance, unique structure, and/or a better balance of desirable properties than prior microporous membranes. Also, the new and/or improved methods produce microporous membranes, and battery separators comprising the same, having a better balance of desirable properties than prior microporous membranes are provided. At least selected methods for making microporous membranes, and battery separators comprising the same, that have a better balance of desirable properties than prior microporous membranes and battery separators are provided. The methods disclosed herein may comprise the following steps: 1.) obtaining a non-porous membrane precursor; 2.) forming a porous biaxially-stretched membrane precursor from the non-porous membrane precursor; 3.) performing at least one of (a) calendering, (b) an additional machine direction (MD) stretching, (c) an additional transverse direction (TD) stretching, (d) pore-filling, and (e) a coating on the porous biaxially stretched precursor to form the final microporous membrane or separator. The possibly preferred microporous membranes or battery separators described herein may have the following desirable balance of properties, prior to application of any coating: a TD tensile strength greater than 200 or greater than 250 kg/cm2, a puncture strength greater than 200, 250, 300, or 400 gf, and a JIS Gurley greater than 50 s.

### Methods

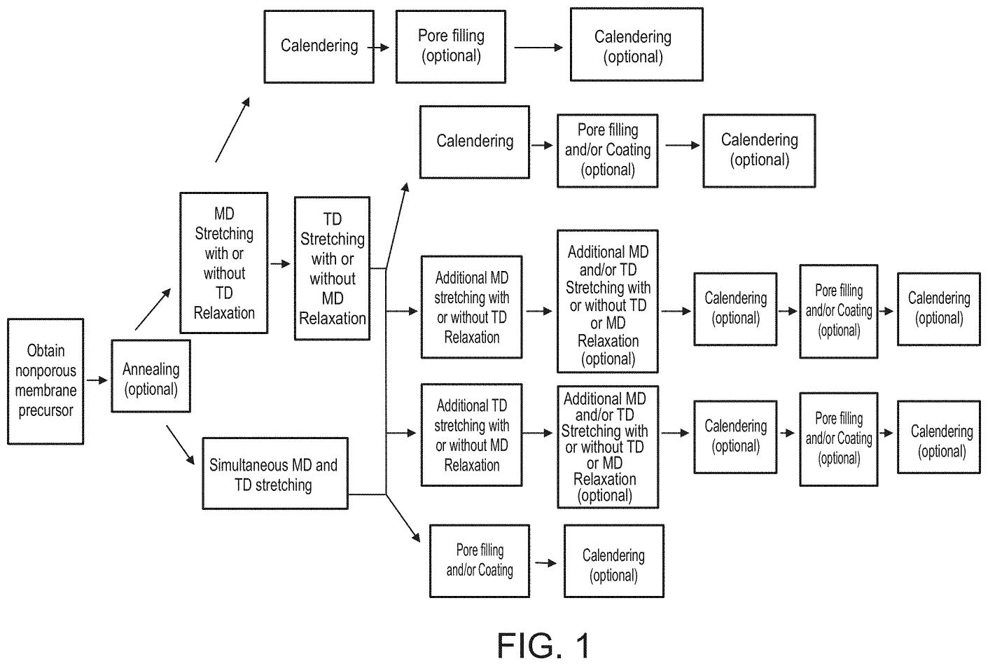

In one aspect or embodiment, a method for making a porous membrane, e.g., a microporous membrane, from a nonporous membrane precursor is described herein. The method comprises, consists of, or consists essentially of the following: (1) obtaining or providing a nonporous precursor; (2) forming a porous biaxially-stretched precursor from the nonporous membrane precursor by simultaneously or sequentially machine direction (MD) and transverse direction (TD) stretching the nonporous membrane precursor; and (3) performing at least one additional step selected from the following: (a) a calendering step, (b) an additional MD stretching step, (c) an additional TD stretching step, (d) a pore-filling step, and (e) a coating on the biaxially stretched precursor membrane. In some embodiments, at least two of the steps (a)-(e) may be performed, e.g., the porous biaxially-stretched membrane precursor may be calendered and then its pores may be filled or the porous biaxially stretched membrane precursor may be subjected to additional MD-stretching and then calendered. In other preferred embodiments, at least three of the steps (a)-(e) may be performed. For example, the porous biaxially-stretched membrane precursor may be subjected to additional MD stretching, calendered, and then have its pores filled. In other embodiments, four or all five of the additional steps (a)-(e) may be performed. For example, the porous biaxially-stretched membrane precursor may be subjected to additional MD stretching and additional TD stretching, calendered, and then subjected to filling of its pores. FIG. 1 is a schematic of some methods for forming a microporous membrane as described herein from a non-porous membrane precursor.

In some embodiments, any one of the additional steps, e.g., calendering, may occur before the MD and/or TD stretching steps used to form the biaxially stretched porous precursor.

(1) Obtaining a Non-Porous Membrane

A nonporous membrane precursor is a membrane without micropores and/or a membrane that has not been stretched, e.g., it has not been machine direction (MD) or transverse direction (TD) stretched. The nonporous membrane is obtained or formed by any method not inconsistent with the stated goals herein, e.g., any method that forms a nonporous membrane precursor as defined herein.

In a preferred embodiment, the nonporous membrane precursor is formed by a method comprising extrusion or co-extrusion of at least one polyolefin selected from polyethylene (PE) and polypropylene (PP), without use of an oil or solvent, e.g., a dry process. In some embodiments, the nonporous membrane precursor is a monolayer or a multilayer, e.g., a bilayer or a trilayer, nonporous membrane precursor. For example, the nonporous membrane may be a monolayer formed by extrusion of at least one polyolefin selected from PE and PP, without using an oil or a solvent. In some embodiments, the nonporous precursor membrane is formed by coextrusion of at least one polyolefin selected from PE and PP, without using an oil or a solvent. Coextrusion may involve passing two or more materials through the same die or passing one or more materials through the same die, where the die is divided into two or more sections. In some embodiments, the nonporous membrane precursor has a trilayer structure and is formed by forming three monolayer, e.g., by extruding or coextruding at least one polyolefin selected from PE and PP, and then laminating the three monolayers together to form a trilayer structure. Lamination may involve bonding the monolayers together with heat, pressure, or both.

In other embodiments, the nonporous membrane precursor is formed as part of a wet manufacturing process, e.g., a process that involves casting of a composition comprising a solvent or oil and a polyolefin to form a monolayer or multilayer nonporous membrane precursor. Such methods also include a solvent or oil recovery step. In other embodiments, the nonporous membrane precursor is formed as part of a beta-nucleated biaxially-oriented (BNBOPP) manufacturing process may be used to produce the non-porous precursor membrane. For example, BNBOPP manufacturing process and beta-nucleating agents disclosed in any one of the following may be used: U.S. Pat. Nos. 5,491,188; 6,235,823; 7,235,203; 6,596,814; 5,681,922; 5,681,922, and 5,231,126 or U.S. Patent Application No. 2006/0091581; 2007/0066687; or 2007/0178324. In other embodiments, an alpha-nucleated biaxially-oriented (αNBOPP) manufacturing process may be used. In still other embodiments, the Bruckner Evapore modified wet process or the particle stretch process may also be used.

In some embodiments, the at least one polyolefin in the non-porous membrane precursor described herein can be an ultra-low molecular weight, a low-molecular weight, a medium molecular weight, a high molecular weight, or an ultra-high molecular weight polyolefin, e.g., a medium or a high weight polyethylene (PE) or polypropylene (PP). For example, an ultra-high molecular weight polyolefin may have a molecular weight of 450,000 (450 k) or above, e.g. 500 k or above, 650 k or above, 700 k or above, 800 k, 1 million or above, 2 million or above, 3 million or above, 4 million, 5 million or above, 6 million or above, etc. A high-molecular weight polyolefin may have a molecular weight in the range of 250 k to 450 k, e.g., 250 k to 400 k, 250 k to 350 k, or 250 k to 300 k. A medium molecular weight polyolefin may have a molecular weight from 150 to 250 k, e.g., 150 k to 225 k, 150 k to 200 k, 150 k to 200 k, etc. A low molecular weight polyolefin may have a molecular weight in the range of 100 k to 150 k, e.g., 100 k to 125 k or 100 to 115 k. An ultra-low molecular weight polyolefin may have a molecular weight less than 100 k. The foregoing values are weight average molecular weights. In some embodiment, a higher molecular weight polyolefin may be used to increase strength or other properties of the microporous membranes or batteries comprising the same as described herein. Wet processes, e.g., processes that employ a solvent or oil, use polymers having a molecular weight of about 600,000 and above. In some embodiments, a lower molecular weight polymer, e.g., a medium, low, or ultra-low molecular weight polymer may be beneficial. For example, without wishing to be bound by any particular theory, it is believed that the crystallization behavior of lower molecular weight polyolefins may result in the formation of a porous uniaxially-stretched or biaxially-stretched precursor as described herein having smaller pores.

The thickness of the non-porous membrane precursor is not so limited and may be from 3 to 100 microns, from 10 to 50 microns, from 20 to 50 microns, or from 30 to 40 microns thick.

In some preferred embodiments, obtaining the nonporous precursor membrane comprises an annealing step, e.g., an annealing step that is performed after the extrusion, co-extrusion, and/or lamination steps described hereinabove. The annealing step may also be performed after a solvent casting and solvent recovery step as described hereinabove are performed. Annealing temperatures are not so limited, and may be between Tm-80° C. and Tm-10° C. (where Tm is the melt temperature of the polymer); and in another embodiment, at temperatures between Tm-50° C. and Tm-15° C. Some materials, e.g., those with high crystallinity after extrusion, such as polybutene, may require no annealing.

(2) Forming a Porous Biaxially-Stretched Precursor

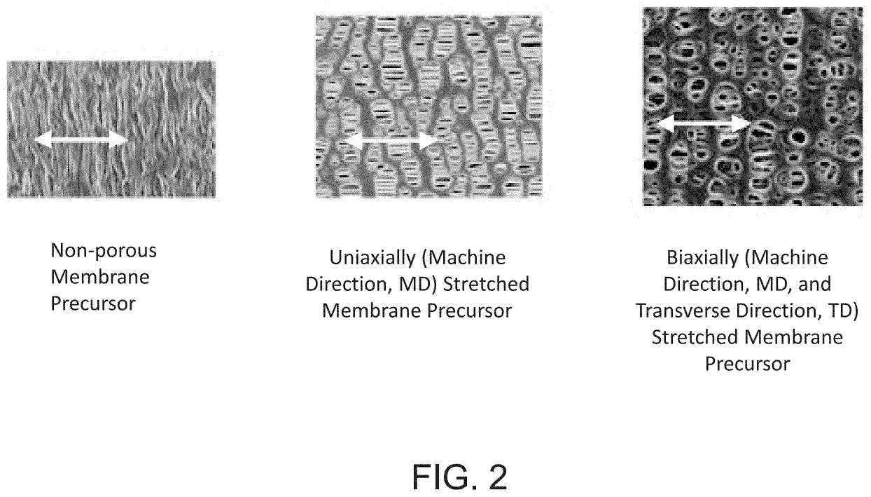

The porous biaxially-stretched precursor contains micro-pores that appear round, e.g., circular, or substantially round. See FIG. 2, which includes a top or birds-eye view of the top of a nonporous precursor membrane, a uniaxially-stretched precursor, and a biaxially-stretched precursor, respectively. In preferred embodiments, the porous biaxially-stretched precursor is formed by stretching a nonporous precursor membrane as described herein, sequentially or simultaneously, in the machine direction (MD) and/or in the transverse direction (TD), which is a direction that is perpendicular to the MD.

(a) Simultaneously

In some embodiments, MD and TD stretching is done simultaneously to form a biaxially-stretched precursor from a nonporous precursor. No uniaxially-stretched precursor, e.g., as described herein below, is formed when MD and TD stretching is performed simultaneously.

(b) Sequentially

In some embodiments, when the stretching is done sequentially, the nonporous precursor membrane is MD stretched first to produce a uniaxially-stretched porous membrane precursor, which is then then TD stretched to form the biaxially-stretched porous membrane precursor. MD stretching makes the nonporous precursor membrane become porous, e.g., microporous. In some embodiments, the MD and TD stretching is done all in one pass, e.g., no other steps are performed between the MD stretching step and the subsequent TD stretching step. One way of distinguishing the uniaxially stretched porous membrane precursor from the biaxially-stretched membrane precursor is by its pore structure. The uniaxially-stretched membrane precursor comprises micro-pores that appear to be slits or elongated openings (see the second surface SEM image or picture in FIG. 2), not round or substantially round-shaped openings like in the biaxially-stretched membrane precursor. The uniaxially-stretched membrane precursor can also be distinguished from the biaxially-stretched membrane precursor by its JIS Gurley value, which is lower due to the smaller pores in the uniaxially-stretched precursor.

This uniaxially-stretched precursor (MD or TD stretched only) may be calendered as described herein so that its thickness is reduced between 10 to 30% or 30% or more, 40% or more, 50% or more, or 60% or more. The uniaxially-stretched precursor can also be coated and/or pore-filled before and/or after calendering.

FIG. 2 shows exemplary pore structure (or lack thereof) for nonporous membrane precursor, a porous uniaxially-stretched membrane precursor, and a porous biaxially stretched membrane precursor. In FIG. 2, the white double-arrowed lines indicate the MD direction.

Machine direction (MD) stretch, e.g., the initial MD stretch to form the uniaxially-stretched membrane precursor, may be connected as a single step or multiple steps, and as a cold stretch, as a hot stretch, or both (e.g., in multistep embodiments where, for example, cold stretching at room temperature is performed and then hot stretching is performed). In one embodiment, cold stretching may be carried out at <Tm-50° C., where Tm is the melting temperature of the polymer in the membrane precursor, and in another embodiment, at <Tm-80° C. In one embodiment, hot stretching may be carried out at <Tm-10° C. In one embodiment, total machine direction stretching may be in the range of 50-500% (i.e., 0.5 to 5λ), and in another embodiment, in the range of 100-300% (i.e., 1 to 3×). This means the length (in the MD direction) of the membrane precursor increases by 50 to 500% or by 100 to 300% compared to the initial length, i.e., before any stretching, during MD stretching. In some preferred embodiments, the membrane precursor is stretched in the range of 180 to 250% (i.e., 1.8 to 2.5×). During machine direction stretch, the precursor may shrink in the transverse direction (conventional). In some preferred embodiments, TD relaxation is performed during or after, preferably after, the MD stretch or during or after, preferably after, at least one step of the MD stretch, including 10 to 90% TD relax, 20 to 80% TD relax, 30 to 70% TD relax, 40 to 60% TD relax, at least 20% TD relax, 50%, etc. Not wishing to be bound by any particular theory, it is believed that performing MD stretching with TD relax keeps the pores that are formed by the MD stretching small. In other preferred embodiments, TD relaxation is not performed.

The machine direction (MD) stretching, particularly the initial or first MD stretching forms pores in the non-porous membrane precursor. MD tensile strength of the uniaxially-stretched (i.e., MD stretched only) membrane precursor is high, e.g., 1500 kg/cm² and above or 200 kg/cm² or above. However, TD tensile strength and puncture strength of these uniaxially-MD stretched membrane precursors are not ideal. Puncture strength, for example, is less than 200, 250, or 300 gf and TD tensile strength, for example, is less than 200 kg/cm² or less than 150 kg/cm².

Transverse direction (TD) stretching of the porous uniaxially-stretched (MD stretched) precursor is not so limited and can be performed in any manner that is not contrary to the stated goals herein. The transverse direction stretching may be conducted as a cold step, as a hot step, or a combination of both (e.g., in a multi-step TD stretching described herein below). In one embodiment, total transverse direction stretching may be in the range of 100-1200%, in the range of 200-900%, in the range of 450-600%, in the range of 400-600%, in the range of 400-500%, etc. In one embodiment, a controlled machine direction relax may be in a range from 5-80%, and in another embodiment, in the range of 15-65%. In one embodiment, TD may be carried out in multiple steps. During transverse direction stretching, the precursor may or may not be allowed to shrink in the machine direction. In an embodiment of a multi-step transverse direction stretching, the first transverse direction step may include a transverse stretch with the controlled machine relax, followed by simultaneous transverse and machine direction stretching, and followed by transverse direction relax and no machine direction stretch or relax. For example, TD stretching may be performed with or without machine direction (MD) relax. In some preferred TD stretching embodiments, MD relax is performed, including 10 to 90% MD relax, 20 to 80% MD relax, 30 to 70% MD relax, 40 to 60% MD relax, at least 20% MD relax, 50% MD relax, etc. The MD and/or TD stretching may be sequential and/or simultaneous stretching with or without relax.

Transverse direction (TD) stretching may improve transverse direction tensile strength and may reduce splittiness of a microporous membrane compared to, for example, a microporous membrane that is not subjected to TD stretching and has only been subjected to machine direction (MD) stretching, e.g., the porous uniaxially-stretched membrane precursor described herein. Thickness may also be reduced, which is desirable. However, TD stretching may also result in decreased JIS Gurley, e.g., a JIS Gurley of less than 100 or less than 50, and increased porosity of the porous biaxially stretched membrane precursor as compared to the porous uniaxially (MD only) stretched membrane precursor, e.g., the porous uniaxially-stretched membrane precursor described herein. This may be due, at least in part, to the larger size of the micro-pores as shown in FIG. 2. Puncture strength (gf) and MD tensile strength (kg/cm²) may also be reduced compared to the porous uniaxially (MD only) stretched membrane precursor

(3) Additional Steps

A method described herein further includes performing at least one of the following additional steps on a porous biaxially-stretched precursor membrane described herein to obtain the final microporous membrane: (a) a calendering step, (b) an additional MD stretching step, (c) an additional TD stretching step, (d) a pore-filling step, and (e) a coating step. In some embodiments, at least two, at least three, or all four of steps (a)-(e) may be performed. See FIG. 1 above, which includes some exemplary embodiments of the inventive methods or embodiments described herein, including what additional steps may be performed and in what order they may be performed. After the porous biaxially stretched membrane precursor or intermediate is subjected to the desired number of additional processing steps, the final microporous membrane is obtained. This final microporous membrane may then, optionally, be subjected to additional processing steps, such as surface treatment steps or coating steps, e.g., a ceramic coating step, to form a battery separator. A stretched and calendered membrane may have the desired thickness (thinness) to allow for a ceramic coating on one or both sides thereof (to enhance safety, block dendrites, add oxidation resistance, or reduce shrinkage) while still meeting the total separator or membrane thickness limit (for example, 16 um, 14 um, 12 um, 10 um, 9 um, 8 um, or less total thickness). However, it is understood that in certain embodiments no additional processing steps are necessary and the final microporous membrane or separator itself may be used as a battery separator or as at least one layer thereof. Two or more inventive membranes may be laminated together to form a multiply or multilayer separator or membrane.

In some embodiments, the above-mentioned additional steps (a)-(d) or (a)-(e) may be performed for the purpose of improving some of the properties that were affected by TD stretching, e.g., the reduced machine direction (MD) tensile strength (kg/cm²), reduced puncture strength (gf), increased COF, and/or decreased JIS Gurley.

(a) a Calendering Step

The calendering step is not so limited and can be performed in any manner not inconsistent with the stated goals herein. For example, in some embodiments the calendering step may be performed as a means to reduce the thickness of the porous biaxially stretched membrane precursor, as a means to reduce the pore size and/or porosity of the porous biaxially stretched membrane precursor in a controlled manner and/or to further improve the transverse direction (TD) tensile strength and/or puncture strength of the porous biaxially stretched membrane precursor Calendering may also improve strength, wettability, and/or uniformity and reduce surface layer defects that have become incorporated during the manufacturing process e.g., during the MD and TD stretching processes. The calendered porous biaxially-stretched final membrane (sometimes no additional steps are performed) or membrane precursor (if other additional steps are to be performed) may have improved coatability (using a smooth calender roll or rolls). Additionally, using a texturized calendering roll may aid in improved coating-to-base membrane adhesion.

Calendering may be cold (below room temperature), ambient (room temperature), or hot (e.g., 90° C.) and may include the application of pressure or the application of heat and pressure to reduce the thickness of a membrane or film in a controlled manner. Calendering may be in one or more steps, for example, low pressure caledering followed by higher pressure calendering, cold calendering followed by hot calendering, and/or the like. In addition, the calendering process may use at least one of heat, pressure and speed to densify a heat sensitive material. In addition, the calendering process may use uniform or non-uniform heat, pressure, and/or speed to selectively densify a heat sensitive material, to provide a uniform or non-uniform calender condition (such as by use of a smooth roll, rough roll, patterned roll, micro-pattern roll, nano-pattern roll, speed change, temperature change, pressure change, humidity change, double roll step, multiple roll step, or combinations thereof), to produce improved, desired or unique structures, characteristics, and/or performance, to produce or control the resultant structures, characteristics, and/or performance, and/or the like.

In possibly preferred embodiments, calendering the porous MD stretched, TD stretched, or biaxially-stretched precursor membrane itself or, for example, a porous biaxially-stretched precursor membrane that has been subjected to one or more of the additional steps disclosed herein, e.g., additional MD stretching, results in novel or improved properties, novel or improved structures, and/or a decrease in the thickness of the membrane precursor, e.g., the porous biaxially-stretched membrane precursor. In some embodiments, the thickness is decreased by 30% or more, by 40% or more, by 50% or more, or by 60% or more. In some preferred embodiments, the membrane or coated membrane thickness is reduced to 10 microns or less, sometimes 9, or 8, or 7, or 6, or 5 microns or less.

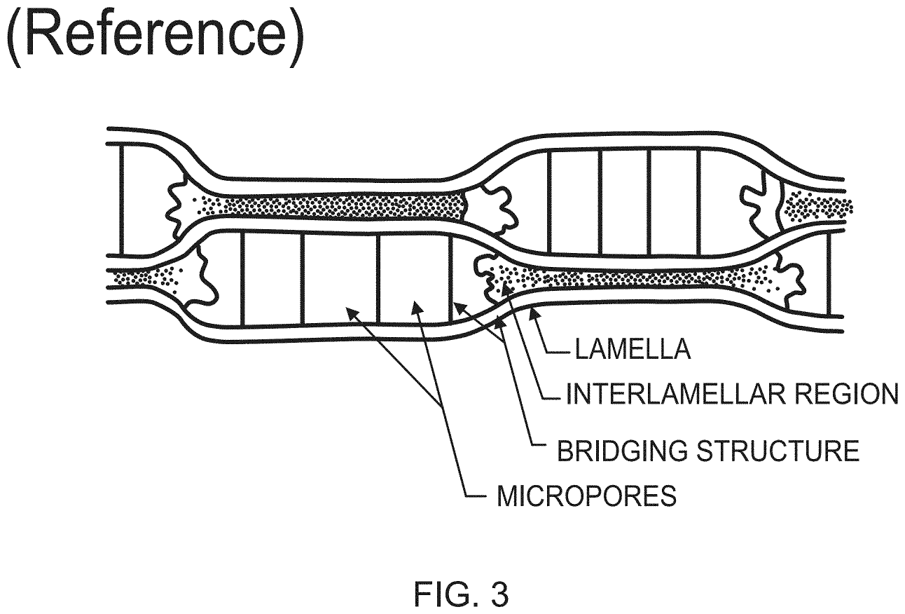

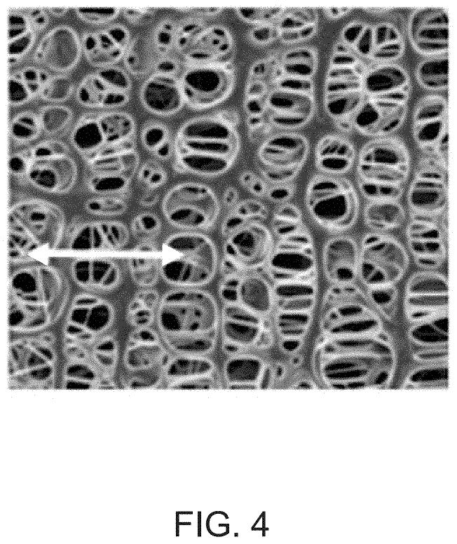

In some embodiments, after calendering, the microporous membrane may have at least one outer surface or surface layer, e.g., one of the layers of the multilayer (2 or more layers) structure described herein above, having a unique pore structure with a pore being the opening or space between adjacent lamellae and which may be bounded on one or both sides by a fibril or bridging structure between the adjacent lamellae and wherein at least a portion of the membrane contains respective groups of pores between adjacent lamellae with the lamellae oriented substantially along a transverse direction and the fibrils or bridging structures between the adjacent lamellae oriented substantially along a machine direction and the outer surface of at least some of the lamellae being substantially flattened or planar, a unique pore structure of angled, aligned, oval (for example, in at least cross-section), or more polymer, plastic or meat between the pores (for example, at the membrane surface), unique or enhanced tortuosity, unique structures (such as aligned or columnar pores in at least membrane cross-section, coated, pore filled, monolayer, and/or multi-layer), unique, thickened, or stacked lamellae, stacked lamellae being compacted vertically, and/or wherein the pore structure having at least one of: substantially trapezoidal or rectangular pores, pores with rounded corners, condensed or heavy lamellae across the width or transverse direction, fairly random or less ordered pores, groups of pores with areas of missing or broken fibrils, densified lamellar skeletal structure, groups of pores with a TD/MD length ratio of at least 4, groups of pores with a TD/MD length ratio of at least 6, groups of pores with a TD/MD length ratio of at least 8, groups of pores with a TD/MD length ratio of at least 9, groups of pores with at least 10 fibrils, groups of pores with at least 14 fibrils, groups of pores with at least 18 fibrils, groups of pores with at least 20 fibrils, pressed or compressed stacked lamellae, a uniform surface, a slightly non-uniform surface, a low COF, and/or wherein the membrane or separator structure having at least one of: a puncture strength (PS) of >300 gf or >400 gf, preferably when normalized for thickness and porosity and/or at 12 um or less thickness, more preferably at 10 um or less thickness, a unique pore structure of angled, aligned, oval (for example, in cross-section view SEM), or more polymer, plastic or meat (for example, in surface view SEM), unique characteristics, specs, or performance of porosity, uniformity (std dev), transverse direction (TD) strength, shrinkage (machine direction (MD) or TD), TD stretch %, MD/TD balance, MD/TD tensile strength balance, tortuosity, and/or thickness, unique structures (such as coated, pore filled, monolayer, and/or multi-layer), and/or combinations thereof. FIG. 3 is a reference diagram labeling the different parts of the micropore structures of the microporous membranes described herein, and FIG. 4 shows one exemplary pore structure of a microporous membrane that has been MD stretched, TD stretched, and then calendered. In FIG. 4, the white double-arrowed line indicates the MD direction.

In some embodiments, one or more coatings, layers or treatments is applied to one or both sides, e.g., a polymer, adhesive, nonconductive, conductive, high temperature, low temperature, shutdown, or ceramic coating, is applied to the biaxially stretched precursor membrane after, before any, or before one of the calendering steps described herein are performed.

(b) An Additional MD Stretching Step

The additional machine direction (MD) stretching step is not so limited and can be performed in any manner that is not inconsistent with the stated goals herein. For example, an additional MD stretching step may be performed to increase, at least, JIS Gurley and/or puncture strength.

In some preferred embodiments, during the additional machine direction (MD) stretching step, the porous biaxially stretched precursor, which may have had other additional steps performed thereon, is stretched between 0.01 and 5.0% (i.e., 0.0001× to 0.05×), between 0.01 and 4.0%, between 0.01 and 3.0%, between 0.03 and 2.0%, between 0.04 and 1.0%, between 0.05 and 0.75%, between 0.06 and 0.50%, between 0.06 and 0.25%, etc. Controlling the TD dimension during this additional MD stretching step may provide further improvement of the properties of the resulting microporous film, e.g., the puncture strength and/or JIS Gurley.

(c) An Additional TD Stretching Step

The additional transverse direction (TD) stretching step is not so limited and can be performed in any manner not inconsistent with the stated goals herein. For example, an additional TD stretching step could be performed to improve at least one of machine direction (MD) tensile strength (kg/cm²), TD tensile (kg/cm²), JIS Gurley, porosity, tortuosity, puncture strength (gf), etc. During the additional TD stretching the membrane precursor may be stretched between 0.01 to 1000%, from 0.01 to 100%, from 0.01 to 10%, from 0.01 to 5%, etc. The additional TD stretching may be performed with or without machine direction (MD) relax. In some preferred embodiments, MD relax is performed, including 10 to 90% MD relax, 20 to 80% MD relax, 30 to 70% MD relax, 40 to 60% MD relax, at least 20% MD relax, 50%, etc. In other preferred embodiments, the additional TD stretching is performed without MD relax.

(d) A Pore-Filling Step

The pore-filling step is not so limited and can be performed in any manner not inconsistent with the stated goals herein. For example, in some embodiments the pores of any biaxially-stretched precursor membrane as described herein may be partially or fully coated, treated or filled with a pore-filling composition, material, polymer, gel polymer, layer, or deposition (like PVD). Preferably, the pore-filling composition coats 50% or more, 60% or more, 70% or more, 80% or more, 90% or more, 95% or more, etc. of the surface area of the pores of any porous biaxially-stretched precursor described herein (or any porous biaxially-stretched precursor membrane to which one or more of the additional steps disclosed herein has been performed). The pore-filling composition may comprise, consist of, or consist essentially of a polymer and a solvent. The solvent may be any suitable solvent useful for forming a composition for coating or filling pores, including organic solvent, e.g., octane, water, or a mixture of an organic solvent and water. The polymer can be any suitable polymer, including an acrylate polymer or a polyolefin, including a low-molecular weight polyoletin. The concentration of the polymer in the pore-filling composition may be between 1 and 30%, between 2 and 25%, between 3 and 20%, between 4 and 15%, between 5 and 10%, etc, but is not so limited, as long as the viscosity of the pore-filling composition is such that the composition can coat the walls of the pores of any porous biaxially-stretched precursor membrane disclosed herein. In some embodiments, the pore-filling solution is applied to the porous biaxially-stretched precursor membrane disclosed herein by any acceptable coating method, e.g., dip-coating (with or without soaking the precursor membrane in the pore-filling solution), spray coating, roll coating, etc. Pore-filling preferably increases either or both of the machine direction (MD) and the transverse direction (TD) tensile strength.

(e) Coating and/or Pore-Filling

The coating step or pore filling step is not so limited and can be performed in any manner not inconsistent with the stated goals herein. The coating step may be performed before or after any of the above-mentioned additional steps (a)-(d). The coating may be any coating that improves the properties of the biaxially-stretched precursor membrane. For example, the coating can be a ceramic coating.

### Microporous Membrane

In another aspect, a microporous membrane having some or each of the following properties is described:

The microporous membrane may be made according to any one of the methods disclosed herein. In some preferred embodiments, the microporous membrane has superior properties, even without the addition of a coating, e.g., a ceramic coating, which may improve these properties.

In some preferred embodiments, the microporous membrane itself, e.g., without any coating thereon, has a thickness ranging from 2 to 50 microns, from 4 to 40 microns, from 4 to 30 microns, from 4 to 20 microns, from 4 to 10 microns, or less than 10 microns. The thickness, e.g., a thickness of 10 microns or less, may be achieved with or without a calendering step. Thickness may be measured in micrometers, μm, using the Emveco Microgage 210-A micrometer thickness tester and test procedure ASTM D374. Thin microporous membranes are preferable for some applications. For example, when used as a battery separator, a thinner separator membrane allows for use of more anode and cathode material in the battery, and consequently, a higher energy and higher power density battery results.

In some preferred embodiments, the microporous membrane may have a JIS Gurley ranging from 20 to 300, 50 to 300, 75 to 300, and or 100 to 300. However, the JIS Gurley value is not so limited and higher, e.g., above 300, or lower, e.g., below 50, JIS Gurley values may be desirable for different purposes. Gurley is defined herein as the Japanese Industrial Standard (JIS Gurley) and is measured herein using the OHKEN permeability tester. JIS Gurley is defined as the time in seconds required for 100 cc of air to pass through one square inch of film at a constant pressure of 4.9 inches of water. JIS Gurley of the entire microporous membrane or of individual layers of the microporous membrane, e.g., an individual layer of a trilayer membrane may be measured. Unless otherwise specified herein, reported JIS Gurley values are those of the microporous membrane.

In some preferred embodiments, the microporous membrane has a puncture strength greater than 200, 250, 300, or 400 (gf), without normalization, or greater than 300, 350, or 400 (gf) at normalized thickness/porosity, e.g., at a thickness of 14 microns and a porosity of 50%. Sometimes the puncture strength is between 300 and 700 (gf), between 300 and 600 (gf), between 300 and 500 (gf), between 300 and 400 (gf), etc. In some embodiments, if it is desirable for a particular application, the puncture strength may be lower than 300 gf or higher than 700 gf, but the range of 300 (gf) to 700 (gf) is a good working range for battery separators, which is one way the disclosed microporous membranes may be used. Puncture Strength is measured using Instron Model 4442 based on ASTM D3763. The measurements are made across the width of the microporous membrane and the puncture strength defined as the force required to puncture the test sample.

As an example, normalization of the measured puncture strength and thickness of any microporous membrane (e.g., having any porosity or thickness) to a thickness of 14 microns and a porosity of 50% is achieved using the following formula (1):

[measured puncture strength (gf) 14 microns·measured porosity]/[measured thickness (microns)·50% porosity] (1)

Normalization of the measured puncture strength values allows thicker and thinner microporous membranes to be compared side-by-side. Thicker microporous membranes made in an identical manner to their thinner counterparts will often have higher puncture strengths due to their greater thickness. In formula (1) a porosity of 50% can be 50/100 or 0.5.

In some preferred embodiments, the microporous membrane has a porosity, e.g., a surface porosity, of about 40 to about 70%, sometimes about 40 to about 65%, sometimes about 40 to about 60%, sometimes about 40 to about 55%, sometimes about 40 to about 50%, sometimes about 40 to about 45%, etc. In some embodiments, if it is desirable for a particular application, the porosity may be higher than 70% or lower than 40%, but the range of 40 to 70% is a working range for battery separators, which is one way the disclosed microporous membranes may be used. Porosity is measured using ASTM D-2873 and is defined as the percentage of void space, e.g., pores, in an area of the microporous membrane, measured in the Machine Direction (MD) and the Transverse Direction (TD) of the substrate. Porosity of the entire microporous membrane or of individual layers of the microporous membrane, e.g., an individual layer of a trilayer membrane may be measured. Unless otherwise specified herein, reported porosity values are those of the microporous membrane.

In some preferred embodiments, the microporous membrane has a high machine direction (MD) and transverse direction tensile strength. Machine Direction (MD) and Transverse Direction (TD) tensile strength are measured using Instron Model 4201 according to ASTM-882 procedure. In some embodiments, the TD tensile strength is 250 kg/cm² or higher, sometimes it is 300 kg/cm² or higher, sometimes 400 kg/cm² or higher, sometimes 500 kg/cm² or higher, and sometimes 550 kg/cm² or higher. Regarding the MD tensile strength, sometimes the MD tensile strength is 500 kg/cm² or higher, 600 kg/cm² or higher, 700 kg/cm² or higher, 800 kg/cm² or higher, 900 kg/cm² or higher, or 1000 kg/cm² or higher. The MD tensile strength may be as high as 2000 kg/cm².

In some preferred embodiments, the microporous membrane has reduced machine direction (MD) and transverse direction (TD) shrinkage even without application of a coating, e.g., a ceramic coating. For example, MD shrinkage at 105° C. may be less than or equal to 20% or less than or equal to 15%. MD shrinkage at 120° C. may be less than or equal to 35%, less than or equal to 29%, less than or equal to 25%, etc. The TD shrinkage at 105° C. may be less than or equal to 10%, 9%, 8%, 7%, 6%, 5%, or 4%. The TD shrinkage at 120° C. may be less than or equal to 12%, 11%, 10%, 9%, or 8%. Shrinkage is measured by placing a test sample, e.g., a microporous membrane without any coating thereon, between two sheets of paper which are then clipped together to hold the sample between the papers and suspended in an oven. For the 105° C. testing, a sample is placed in an oven at 105° C. for a length of time, e.g., 10 minutes, 20 minutes, or one hour. After the designated heating time in the oven, each sample is removed and taped to a flat counter surface using double side sticky tape to flatten and smooth out the sample for accurate length and width measurement. Shrinkage is measured in the both the MD, i.e., to measure MD shrinkage, and TD direction (perpendicular to the MD direction), i.e., to measure TD shrinkage, and is expressed as a % MD shrinkage and % TD shrinkage.

In some preferred embodiments, average dielectric breakdown of the microporous membrane is between 900 and 2000 Volts. Dielectric breakdown voltage was determined by placing a sample of the microporous membrane between two stainless steel pins, each 2 cm in diameter and having a flat circular tip, and applying an increasing voltage across the pins using a Quadtech Model Sentry 20 hipot tester, and recording the displayed voltage (the voltage at which current arcs through the sample).

In some preferred embodiments, the microporous membrane has each of the following properties, without or prior to application of any coating, e.g., a ceramic coating: a TD tensile strength greater than 200 or greater than 250 kg/cm², a puncture strength, with or without normalization, greater than 200, 250, 300, or 400 gf, and a JIS Gurley greater than 20 or 50 s. In some embodiments the JIS Gurley is between 20 and 300 s, 50 and 300 s or between 100 and 300 s, and the TD tensile strength greater than 250 kg/cm² (sometimes greater than 550 kg/cm²) and the puncture strength greater than 300 gf. In some embodiments, the puncture strength is between 300 and 600 (gf), with or without normalization for thickness and porosity, e.g., a thickness of 14 microns and a porosity of 50%, or sometimes the puncture strength is between 400 and 600 (gf), with or without normalization for thickness and porosity, e.g., a thickness of 14 microns and a porosity of 50%, and the TD tensile strength is greater than 250 kg/cm² (sometimes about 550 kg/cm² or higher) and the JIS Gurley is greater than 20 or 50 s. In some embodiments, the TD tensile strength is between 250 kg/cm² and 600 kg/cm², between 200 and 550 kg/cm², between 250 and 590 kg/cm², or between 250 and 500 kg/cm², and the JIS Gurley is greater than 20 or 50 s and the puncture strength is greater than 300 (gf).

In some preferred embodiments, the MD/TD tensile strength ratio may be from 1 to 5, from 1.45 to 2.2, from 1.5-5, from 2 to 5, etc.

The microporous membranes and separators disclosed herein may have improved thermal stability as shown, for example, by desirable behavior in hot tip hole propagation studies. The hot tip test measures the dimensional stability of the microporous membrane under point heating condition. The test involves contacting the separators with a hot soldering iron tip and measuring the resulting hole. Smaller holes are generally more desirable. In some embodiments, hot tip propagation values may be from 2 to 5 mm, from 2 to 4 mm from 2 to 3 mm or less than these values.

In some embodiments, tortuosity may be greater than 1, 1.5, or 2, or higher, but preferably between 1 and 2.5. It has been discovered to be advantageous to have a microporous separator membrane with high tortuosity between the electrodes in a battery in order on order to avoid cell failure. A membrane with straight through pores is defined as having a tortuosity of unity. Tortuosity values greater than 1 are desired in at least certain preferred battery separator membranes that inhibit the growth of dendrites. More preferred are tortuosity values greater than 1.5. Even more preferred are separators with tortuosity values greater than 2. Without wishing to be bound by any particular theory, the tortuosity of the microporous structure of at least certain preferred dry and/or wet process separators (such as Celgard® battery separators) may play a vital role in controlling and inhibiting dendrite growth. The pores in at least certain Celgard® microporous separator membranes may provide a network of interconnected tortuous pathways that limit the growth of dendrite from the anode, through the separator, to the cathode. The more winding the porous network, the higher the tortuosity of the separator membrane.

In some embodiments, the coefficient of friction (COF) or static friction may be less than 1, less than 0.9, less than 0.8, less than 0.7, less than 0.6, less than 0.5, less than 0.4, less than 0.3, less than 0.2, etc. COF (Coefficient of friction) Static is measured according to JIS P 8147 entitled “Method for Determining Coefficient of Friction of Paper and Board.”

Pin removal force may be less than 1000 grams-force (gf), less than 900 gf, less than 800 gf, less than 700 gf, less than 600 gf, etc. A test for pin removal is described herein below:

A battery winding machine was used to wind the separator (which comprises, consists of, or consists essentially of a porous substrate with a coating layer applied on at least one surface thereof) around a pin (or core or mandrel). The pin is a two (2) piece cylindrical mandrel with a 0.16 inch diameter and a smooth exterior surface Each piece has a semicircular cross section. The separator, discussed below, is taken up on the pin. The initial force (tangential) on the separator is 0.5 kgf and thereafter the separator is wound at a rate of ten (10) inches in twenty four (24) seconds. During winding, a tension roller engages the separator being wound on the mandrel. The tension roller comprises a ⅝″ diameter roller located on the side opposite the separator feed, a ¾″ pneumatic cylinder to which 1 bar of air pressure is applied (when engaged), and a ¼″ rod interconnecting the roller and the cylinder.

The separator consists of two (2) 30 mm (width)×10″ pieces of the membrane being tested. Five (5) of these separators are tested, the results averaged, and the averaged value is reported. Each piece is spliced onto a separator feed roll on the winding machine with a 1″ overlap. From the free end of the separator, i.e., distal the spliced end, ink marks are made at ½″ and 7″. The ½″ mark is aligned with the far side of the pin (i.e., the side adjacent the tension roller), the separator is engaged between the pieces of the pin, and winding is begun with the tension roller engaged. When the 7″ mark is about ½″ from the jellyroll (separator wound on the pin), the separator is cut at that mark, and the free end of the separator is secured to the jellyroll with a piece of adhesive tape (1″ wide, ½″ overlap). The jellyroll (i.e., pin with separator wound thereon) is removed from the winding machine. An acceptable jellyroll has no wrinkles and no telescoping.

The jellyroll is placed in a tensile strength tester (i.e., Chatillon Model TCD 500-MS from Chatillon Inc., Greensboro, N.C.) with a load cell (50 lbs×0.02 lb Chatillon DFGS 50). The strain rate is 2.5 inches per minute and data from the load cell is recorded at a rate of 100 points per second. The peak force is reported as the pin removal force.

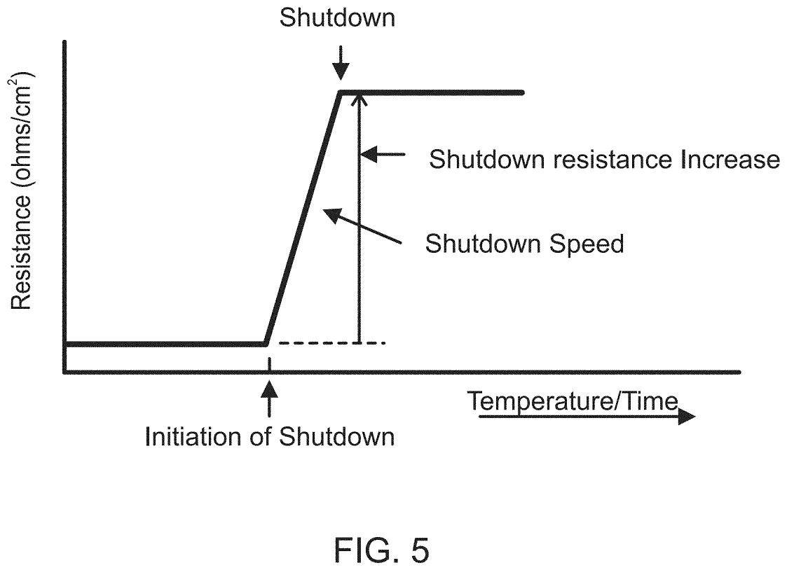

In some embodiments that microporous membranes may exhibit improved shutdown properties when used as a battery separator. Preferred thermal shutdown characteristics are lower onset or initiation temperature, faster or more rapid shutdown speed, and a sustained, consistent, longer or extended thermal shutdown window. In a preferred embodiment, the shutdown speed is, at a minimum, 2000 ohms (Ω)·cm²/second or 2000 ohms (Ω)·cm²/degree and the resistance across the separator increases by a minimum of two orders of magnitude at shutdown. One example of shutdown performance is shown FIG. 5.

A shutdown window as described herein generally refers to the time/temperature window spanning from initiation or onset of shutdown, e.g., the time/temperature at which the separator first begins to melt enough to close the pores thereof resulting in stopping or slowing of ionic flow, e.g., between an anode and a cathode, and/or increase in resistance across the separator, until a time/temperature at which the separator begins to break down, e.g., decompose, causing ionic flow to resume and/or resistance across the separator to decrease.

Shutdown can be measured using Electrical Resistance testing which measures the electrical resistance of the separator membrane as a function of temperature. Electrical resistance (ER) is defined as the resistance value in ohm-cm² of a separator filled with electrolyte. Temperature may be increased during Electrical Resistance (ER) testing at a rate of 1 to 10° C. per minute. When thermal shutdown occurs in a battery separator membrane, the ER reaches a high level of resistance on the order of approximately 1,000 to 10,000 ohm-cm². A combination of a lower onset temperature of thermal shutdown and a lengthened shutdown temperature duration increases the sustained “window” of shutdown. A wider thermal shutdown window can improve battery safety by reducing the potential of a thermal runaway event and the possibility of a fire or an explosion.

One exemplary method for measuring the shutdown performance of a separator is as follows: 1) Place a few drops of electrolyte onto a separator to saturate it, and place the separator into the test cell; 2) Make sure that a heated press is below 50-C, and if so, place the test cell between the platens and compress the platens slightly so that only a light pressure is applied to the test cell (<50 lbs for a Carver “C” press); 3) Connect the test cell to an RLC bridge and begin recording temperature and resistance. When a stable baseline is attained, then start ramping the temperature of the heated press at 10-C/min using the temperature controller; 4) turn off the heated platens when the maximum temperature is reached or when the separator impedance drops to a low value; and 5) Open the platens and remove the test cell. Allow test cell to cool. Remove separator and dispose of.

In some preferred embodiments, the microporous membrane is coated on one or both sides with a coating, e.g., a ceramic coating, that improves at least one of the above-mentioned properties.

### Battery Separator

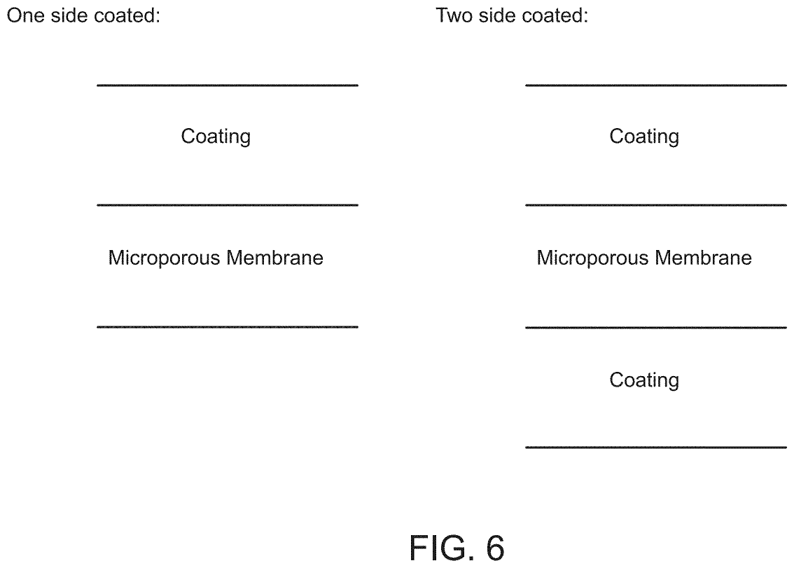

In another aspect, a battery separator comprising, consisting of, or consisting essentially of at least one microporous membrane as disclosed herein is described in some embodiments, the at least one microporous membrane may be coated on one or two sides to form a one or two-side coated battery separator. One-side coated (OSC) separators and two-side coated (TSC) battery separators according to some embodiments herein are shown in FIG. 6.

The coating layer may comprise, consist of, or consist essentially of, and/or be formed from, any coating composition. For example, any coating composition described in U.S. Pat. No. 6,432,586 may be used. The coating layer may be wet, dry, cross-linked, uncross-linked, etc.

In one aspect, the coating layer may be an outermost coating layer of the separator, e.g., it may have no other different coating layers formed thereon, or the coating layer may have at least one other different coating layer formed thereon. For example, in some embodiments, a different polymeric coating layer may be coated over or on top of the coating layer formed on at least one surface of the porous substrate. In some embodiments, that different polymeric coating layer may comprise, consist of, or consist essentially of at least one of polyvinylidene difluoride (PVdF) or polycarbonate (PC).

In some embodiments, the coating layer is applied over top of one or more other coating layers that have already been applied to at least one side of the microporous membrane. For example, in some embodiments, these layers that have already been applied to a the microporous membrane are thin, very thin, or ultra-thin layers of at least one of an inorganic material, an organic material, a conductive material, a semi-conductive material, a non-conductive material, a reactive material, or mixtures thereof. In some embodiments, these layer(s) are metal or metal oxide-containing layers. In some preferred embodiments, a metal-containing layer and a metal-oxide containing layer, e.g., a metal oxide of the metal used in the metal-containing layer, are formed on the porous substrate before a coating layer comprising a coating composition described herein is formed. Sometimes, the total thickness of these already applied layer or layers is less than 5 microns, sometimes, less than 4 microns, sometimes less than 3 microns, sometimes less than 2 microns, sometimes less than 1 micron, sometimes less than 0.5 microns, sometimes less than 0.1 microns, and sometimes less than 0.05 microns.

In some embodiments, the thickness of the coating layer formed from the coating compositions described hereinabove, e.g., the coating compositions described in U.S. Pat. No. 8,432,586, is less than about 12 μm, sometimes less than 10 μm, sometimes less than 9 μm, sometimes less than 8 μm, sometimes less than 7 μm, and sometimes less than 5 μm. In at least certain selected embodiments, the coating layer is less than 4 μm, less than 2 μm, or less than 1 μm.

The coating method is not so limited, and the coating layer described herein may be coated onto a porous substrate, e.g., as described herein, by at least one of the following coating methods: extrusion coating, roll coating, gravure coating, printing, knife coating, air-knife coating, spray coating, dip coating, or curtain coating. The coating process may be conducted at room temperature or at elevated temperatures.

The coating layer may be any one of nonporous, nanoporous, microporous, mesoporous or macroporous. The coating layer may have a JIS Gurley of 700 or less, sometimes 600 or less, 500 or less, 400 or less, 300 or less, 200 or less, or 100 or less. For a nonporous coating layer, the JIS Gurley can be 800 or more, 1,000 or more, 5,000 or more, or 10,000 or more (i.e., “infinite Gurley”) For a nonporous coating layer, although the coating is nonporous when dry, it is a good ionic conductor, particularly when it becomes wet with electrolyte.

Composite or Device A composite or device (cell, system, battery, capacitor, etc.) comprising any battery separator as described hereinabove and one or more electrodes, e.g., an anode, a cathode, or an anode and a cathode, provided in direct contact therewith. The type of electrodes are not so limited. For example the electrodes can be those suitable for use in a lithium ion secondary battery. At least selected embodiments of the present invention may be well suited for use with or in modern high energy, high voltage, and/or high C rate lithium batteries, such as CE, UPS, or EV, EDV, ISS or Hybrid vehicle batteries, and/or for use with modem high energy, high voltage, and/or high or quick charge or discharge electrodes, cathodes, and the like. At least certain thin (less than 12 um, preferably less than 10 um, more preferably less than 8 um) and/or strong or robust dry process membrane or separator embodiments of the present invention may be especially well suited for use with or in modem high energy, high voltage, and/or high C rate lithium batteries (or capacitors), and/or for use with modern high energy, high voltage, and/or high or quick charge or discharge electrodes, cathodes, and the like.

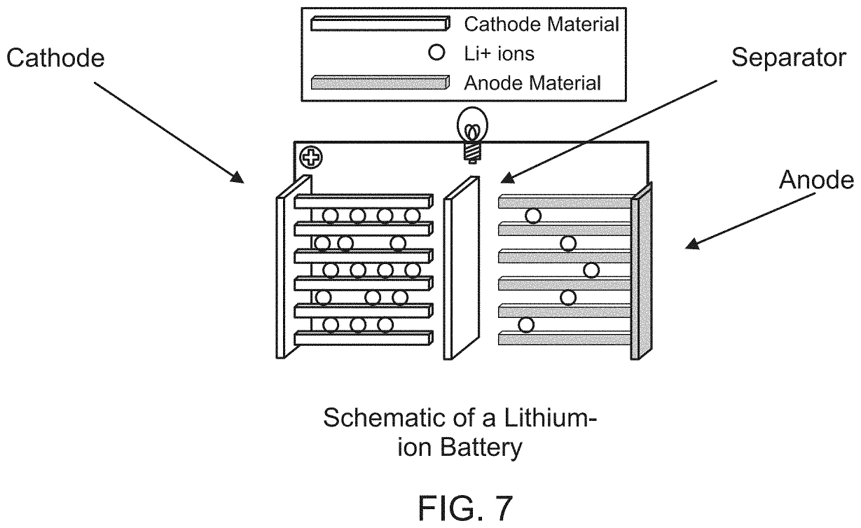

A lithium-ion battery according to at least some embodiments herein is shown in FIG. 7.

A suitable anode can have an energy capacity greater than or equal to 372 mAh/g, preferably ≥700 mAh/g, and most preferably ≥1000 mAH/g. The anode be constructed from a lithium metal foil or a lithium alloy foil (e.g. lithium aluminum alloys), or a mixture of a lithium metal and/or lithium alloy and materials such as carbon (e.g. coke, graphite), nickel, copper. The anode is not made solely from intercalation compounds containing lithium or insertion compounds containing lithium.

A suitable cathode may be any cathode compatible, with the anode and may include an intercalation compound, an insertion compound, or an electrochemically active polymer. Suitable intercalation materials includes, for example, MOS₂, FeS₂, MnO₂, TiS₂, NbSe₃, LiCOO₂, LiNiO₂, LiMn₂O₄, V₆O₁₃, V₂O₅, and CuCl₂. Suitable polymers include, for example, polyacetylene, polypyrrole, polyaniline, and polythiopene.

Any battery separator described hereinabove may be incorporated to any vehicle, e.g., an e-vehicle, or device, e.g., a cell phone or laptop, that is completely or partially battery powered.

Various embodiments of the invention have been described in fulfillment of the various objects of the invention. It should be recognized that these embodiments are merely illustrative of the principles of the present invention. Numerous modifications and adaptations will be readily apparent to those skilled in the art without departing from the spirit and scope of this invention.

### Examples

### (1) Examples with Calendering

### Example 1(a)

In one example, a trilayer non-porous precursor comprising a polyethylene (PE)-containing layer, a polypropylene (PP)-containing layer, and a PE-containing layer, in that order, i.e., a PE/PP/PE trilayer, was formed by extruding three layers comprising these polymers, e.g., two PE layers and a PP layer, without the use of a solvent or oil, and then laminating these layers together to form the PE/PP/PE trilayer. The non-porous PE/PP/PE precursor was then MD stretched and the properties, e.g., thickness, JIS Gurley, Porosity, Puncture Strength, MD tensile strength, TD tensile strength, MD elongation, TD elongation, MD shrinkage (at 105° C. and at 120° C.), TD shrinkage (at 105° C. and 120° C.), and dielectric break down were measured as described herein above. The results are reported in Table 1 below. Then the porous MD-stretched (or porous uniaxially-stretched) PE/PP/PE trilayer was TD stretched and the same properties of this porous MD and TD stretched (or porous biaxially-stretched) PE/PP/PE trilayer were measured and recorded in Table 1 below. Next, the MD and TD stretched (or porous biaxially-stretched) PE/PP/PE trilayer was calendered and the properties of this calendered porous MD and TD stretched (or porous biaxially-stretched) PE/PP/PE trilayer were measured and are reported in Table 1 below.

TABLE 1

| | | | Calendered |
|---|---|---|---|
| | | MD and TD- | MD and TD- |
| | MD-Stretched | Stretched | stretched |
| | PE/PP/PE | PE/PP/PE | PE/PP/PE |
| | trilayer | trilayer | trilayer |
| Thickness (μm) | 35.6 | 25.5 | 13.2 |
| Gurley, JIS (s) | 677 | 36 | 51 |
| Porosity (%) | 43 | 69 | 53 |
| Puncture | 427 | 198 | 201 |
| Strength(gf) | | | |
| MD Tensile | 1801 | 539 | 927 |
| Strength (kg/cm²) | | | |
| TD Tensile | 147 | 315 | 473 |
| Strength (kg/cm²) | | | |
| MD Elongation | 55 | 108 | 75 |
| (%) | | | |
| TD Elongation | 608 | 82 | 75 |
| (%) | | | |
| MD Shrinkage | 4 | 16 | 14 |
| at 105° C. (%) | | | |
| MD Shrinkage | 14 | 31 | 21 |
| at 120° C. (%) | | | |
| TD Shrinkage | About zero | 3 | 4 |
| at 105° C. (%) | | | |
| TD Shrinkage | About zero | 7 | 8 |
| at 120° C. (%) | | | |
| Average | 3767 | 1100 | 1100 |
| Dielectric | | | |
| Breakdown (V) | | | |

### Example 1(b)

In another example, a PE/PP/PE trilayer was formed like that in Example 1(a) above, except that a stronger, e.g., a higher molecular weight, PP resin was used. The PP resin has a molecular weight of about 450 k. The same measurements taken in Example 1(a) were taken here and are reported in Table 2 below.

TABLE 2

| | | | Calendered |
|---|---|---|---|
| | | MD and TD- | MD and TD- |
| | MD-Stretched | Stretched | stretched |
| | PE/PP/PE | PE/PP/PE | PE/PP/PE |
| | trilayer | trilayer | trilayer |
| Thickness (μm) | 55.3 | 39.3 | 24 |
| Gurley, JIS (s) | 1550 | 70 | 105 |
| Porosity (%) | 41 | 76 | 54 |
| Puncture | 629 | 325 | 316 |
| Strength(gf) | | | |
| MD Tensile | 1955 | 650 | 1186 |
| Strength (kg/cm²) | | | |
| TD Tensile | 157 | 369 | 388 |
| Strength (kg/cm²) | | | |
| MD Elongation | 72 | 99 | 97 |
| (%) | | | |
| TD Elongation | 547 | 87 | 131 |
| (%) | | | |
| MD Shrinkage | 3 | 17 | 15 |
| at 105° C. (%) | | | |
| MD Shrinkage | 8 | 31 | 22 |
| at 120° C. (%) | | | |
| TD Shrinkage | About zero | 5 | 5 |
| at 105° C. (%) | | | |
| TD Shrinkage | About 0 | 11 | 10 |
| at 120° C. (%) | | | |
| Average | Not tested | Not tested | 1795 |
| Dielectric | | | |
| Breakdown (V) | | | |

### Example 1(c)

In one example, a trilayer non-porous precursor comprising a polypropylene (PP)-containing layer, a polyethylene (PE)-containing layer, and a PP-containing layer, in that order, i.e., a PP/PE/PP trilayer was formed by extruding three layers comprising these polymers, e.g., two PP layers and a single PE layer, without the use of a solvent or oil, and then laminating these layers together to form the PP/PE/PE trilayer. The non-porous PP/PE/PP precursor was then MD stretched and the properties, e.g., thickness, JIS Gurley, Porosity, Puncture Strength, MD tensile strength, TD tensile strength, MD elongation, TD elongation, MD shrinkage (at 105° C. and at 120° C.), TD shrinkage (at 105° C. and 120° C.), and dielectric break down were measured as described herein above. The results are reported in Table 3 below. Then the porous MD-stretched (or porous uniaxially-stretched) PP/PE/PP trilayer was TD stretched and the same properties of this porous MD and TD stretched (or porous biaxially-stretched) PP/PE/PP trilayer were measured and recorded in Table 3 below. Next, the MD and TD stretched (or porous biaxially-stretched) PP/PE/PP was calendered and the properties of this calendered porous MD and TD stretched (or porous biaxially-stretched) PP/PE/PP trilayer were measured and are reported in Table 3 below.

TABLE 3

| | | | Calendered |
|---|---|---|---|
| | | MD and TD- | MD and TD- |
| | MD-Stretched | Stretched | stretched |
| | PP/PE/PP | PP/PE/PP | PP/PE/PP |
| | trilayer | trilayer | trilayer |
| Thickness (μm) | 37.6 | 25.8 | 13.5 |
| Gurley, JIS (s) | 1015 | 40 | 148 |
| Porosity (%) | 42 | 60 | 53 |
| Puncture | 675 | 296 | 295 |
| Strength(gf) | | | |
| MD Tensile | 1793 | 621 | 1127 |
| Strength (kg/cm²) | | | |
| TD Tensile | 141 | 313 | 528 |
| Strength (kg/cm²) | | | |
| MD Elongation | 44 | 98 | 83 |
| (%) | | | |
| TD Elongation | 960 | 137 | 141 |
| (%) | | | |
| MD Shrinkage | 2 | 18 | 12.76 |
| at 105° C. (%) | | | |
| MD Shrinkage | 9 | 29 | 19.88 |
| at 120° C. (%) | | | |
| TD Shrinkage | About zero | 5 | 6.17 |
| at 105° C. (%) | | | |
| TD Shrinkage | About zero | 12 | 9.11 |
| at 120° C. (%) | | | |
| Average | 4400 | 1545 | 919 |
| Dielectric | | | |
| Breakdown (V) | | | |

### Example 1(d)

In another embodiment a PP/PE/PP trilayer was formed and tested like in Example 1(c) hereinabove, except that the thickness of the PP and PE layers were varied. The PP layers were thicker and the PE layer was thinner. The results of the tests are presented in Table 4 below:

TABLE 4

| | | | Calendered |
|---|---|---|---|
| | | MD and TD- | MD and TD- |
| | MD-Stretched | Stretched | stretched |
| | PP/PE/PP | PP/PE/PP | PP/PE/PP |
| | trilayer | trilayer | trilayer |
| Thickness (μm) | 33 | 21 | 10 |
| Gurley, JIS (s) | 431 | 45 | 194 |
| Porosity (%) | 46 | 73 | 39 |
| Puncture | 610 | 217 | 320 |
| Strength(gf) | | | |
| MD Tensile | 1775 | 761 | 1101 |
| Strength (kg/cm²) | | | |
| TD Tensile | 143 | 343 | 566 |
| Strength (kg/cm²) | | | |
| MD Elongation | 61 | 117 | 64 |
| (%) | | | |
| TD Elongation | 916 | 139 | 107 |
| (%) | | | |
| MD Shrinkage | 2.19 | 11.85 | 7.81 |
| at 105° C. (%) | | | |
| MD Shrinkage | 10.24 | 27.15 | 14.58 |
| at 120° C. (%) | | | |
| TD Shrinkage | −.25 | 1.04 | 4.56 |
| at 105° C. (%) | | | |
| TD Shrinkage | −.60 | 4.18 | 8.00 |
| at 120° C. (%) | | | |
| Average | Not yet | Not yet | Not yet |
| Dielectric | measured | measured | measured |
| Breakdown (V) | | | |

### Example 1(e)

In another embodiment a PP/PE/PP trilayer was formed and tested like in Example 1(d) hereinabove, except that different PP and PE resins were used. The results of the tests are presented in Table 5 below:

TABLE 5

| | | | Calendered |
|---|---|---|---|
| | | MD and TD- | MD and TD- |
| | MD-Stretched | Stretched | stretched |
| | PP/PE/PP | PP/PE/PP | PP/PE/PP |
| | trilayer | trilayer | trilayer |
| Thickness (μm) | 35 | 23 | 14 |
| Gurley, JIS (s) | 778 | 57 | 88 |
| Porosity (%) | 45.5 | 70.6 | 57 |
| Puncture | 655 | 274 | 237 |
| Strength(gf) | | | |
| MD Tensile | 1737 | 686 | 929 |
| Strength (kg/cm²) | | | |
| TD Tensile | 139 | 317 | 496 |
| Strength (kg/cm²) | | | |
| MD Elongation | 52 | 100 | 85 |
| (%) | | | |
| TD Elongation | 931 | 136 | 89 |
| (%) | | | |
| MD Shrinkage | 13.5 | 27 | 18 |
| at 120° C. (%) | | | |
| TD Shrinkage | −.52 | 5.5 | 6 |
| at 120° C. (%) | | | |

### Example 1(f)

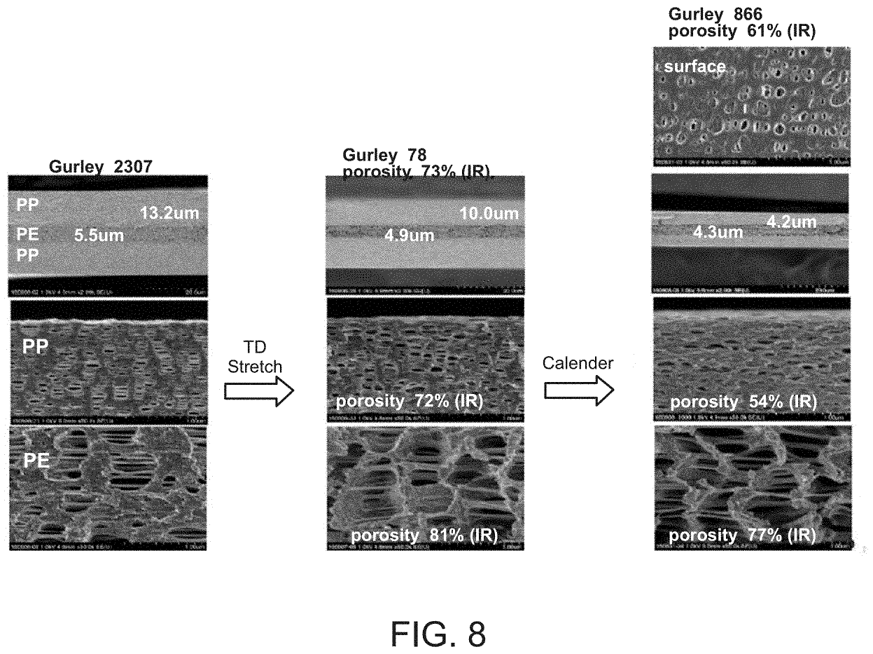

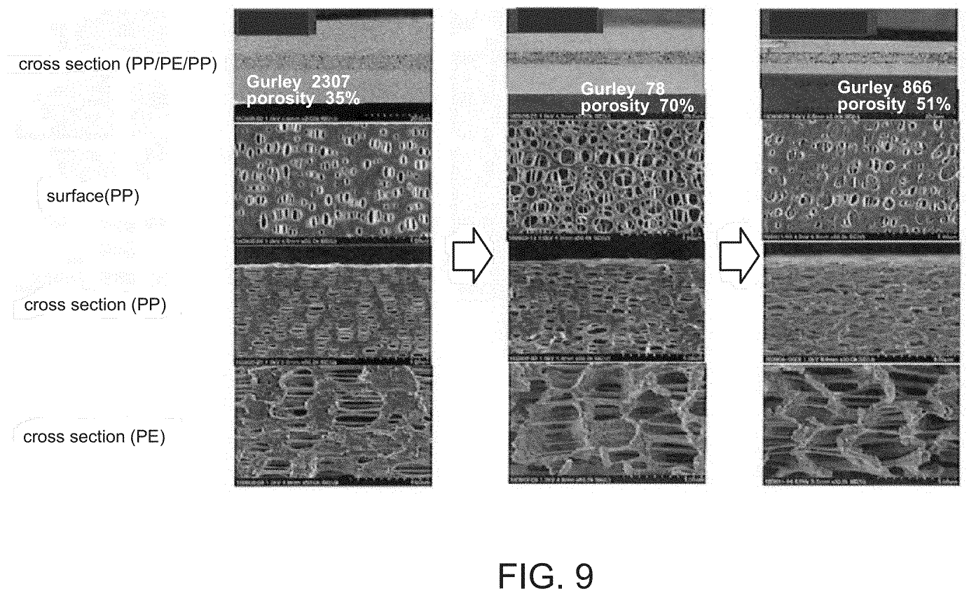

In another Example, a trilayer non-porous precursor comprising a polypropylene (PP)-containing layer, a polyethylene (PE)-containing layer, and a PP-containing layer, in that order, i.e., a PP/PE/PP trilayer was formed by extruding three layers comprising these polymers, e.g., two PP layers and a single PE layer, without the use of a solvent or oil, and then laminating these layers together to form the PP/PE/PE trilayer. The non-porous PP/PE/PP trilayer precursor was then MD stretched, then TD stretched, and finally, calendered. Images of the trilayer, along with recorded JIS Gurley and porosity, after each step are provided in FIGS. 8 and 9.

### Example 1(g)

In an Example, a non-porous polypropylene (PP) monolayer is formed by extrusion, without the use of a solvent or an oil. The non-porous PP monolayer was MD stretched, then TD stretched, and then calendered. The thickness, MD tensile strength, TD tensile strength, puncture strength (normalized and not normalized), Gurley (s), and porosity were measured as described hereinabove, and the results are reported in Table 6 below. In Table 6, the MD and TD-stretched PP-monolayer and the Calendered MD and TD-stretched PP monolayer are compared to a conventional MD only (a product that is only MD stretched and not later TD stretched and/or calendered).

TABLE 6

| | | | Calendered |
|---|---|---|---|
| | Conventional | MD and TD- | MD and TD- |
| | MD-Only | Stretched PP | stretched PP- |
| | Monolayer | monlayer | monolayer |
| Thickness (μm) | 12 | 12 | 10 |
| JIS Gurley(s) | 120 | 28 | 140 |
| Porosity (%) | 51 | 68 | 41 |
| Puncture | 220 | 190 | 360 |
| Strength(gf) | | | |
| Puncture | 262 | 301 | 413 |
| Strength (gf) | | | |
| normalized for | | | |
| 14 micron | | | |
| thickness and | | | |
| 50% porosity | | | |
| MD Tensile | 1900 | 900 | 1700 |
| Strength (kg/cm²) | | | |
| TD Tensile | 130 | 500 | 1,150 |
| Strength (kg/cm²) | | | |

### Example 1(h)

In an Example, a non-porous PP/PE/PP trilayer is formed by extrusion, without the use of a solvent or an oil. The non-porous PP/PE/PP trilayer was MD stretched, then TD stretched, and then calendered. One embodiment used a regular molecular weight PP and the other used a high molecular weight PP having a weight average molecular weight of about 450 k. The thickness, MD tensile strength, TD tensile strength, puncture strength, Gurley (s), and porosity were measured as described hereinabove, and the results are reported in Table 7 below. In Table 7 below, the MD and TD stretched and the Calendered MD and TD stretched trilayers were compared to a conventional MD-only PP/PE/PP trilayer (a trilayer that was not later TD stretched and/or calendered).

TABLE 7

| | | | | Calendered |
|---|---|---|---|---|
| | | | | MD and TD- |
| | | | Calendered | stretched |
| | Conventional | MD and TD- | MD and TD- | PP/PE/PP |
| | MD-only | Stretched | stretched | trilayer |
| | PP/PE/PP | PP/PE/PP | PP/PE/PP | High |
| | trilayer | trilayer | trilayer | Molecular |
| | Regular Molecular Weight | | | Weight |
| Thickness | 12 | 16 | 12 | 12 |
| (μm) | | | | |
| JIS Gurley(s) | 230 | 40 | 170 | 870 |
| Porosity (%) | 42 | 70 | 54 | 51 |
| Puncture | 280 | 200 | 310 | 410 |
| Strength(gf) | | | | |
| Puncture | 274 | 245 | 391 | 488 |
| Strength (gf) | | | | |
| normalized for | | | | |
| 14 micron | | | | |
| thickness and | | | | |
| 50% porosity | | | | |
| MD Tensile | 2230 | 750 | 1150 | 1990 |
| Strength | | | | |
| (kg/cm²) | | | | |
| TD Tensile | 140 | 340 | 580 | 480 |
| Strength | | | | |
| (kg/cm²) | | | | |

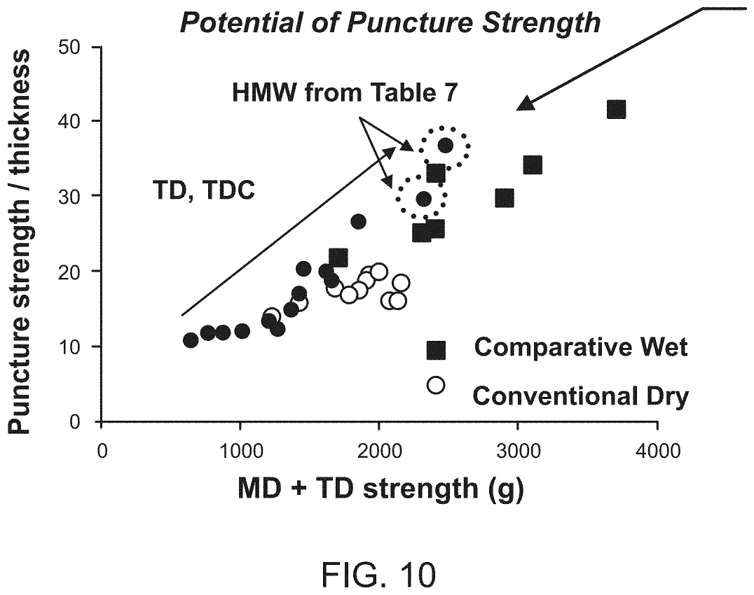

FIG. 10 shows that HMW Calendered MD and TD stretched PP/PE/PP trilayer performs better than conventional dry, e.g., conventional NMD-only PP/PE/PP trilayer, and as well as a comparative wet product without requiring the use of solvent and oils as required by a wet process.

### Example 1(i)

In an Example, a multilayer non-porous precursor is formed by co-extruding a (PP/PP/PP) trilayer, co-extruding a (PE/PE/PE) trilayer, and laminating a single (PE/PE/PE) trilayer between two (PP/PP/PP) trilayers. The structure of the resulting multilayer precursor is (PP/PP/PP)/(PE/PE/PE)/(PP/PPiPP). Co-extrusion is performed without the use of solvents or oils. The non-porous multilayer precursor was M stretched, then TD stretched, and then calendered. The thickness, M tensile strength, TD tensile strength, puncture strength, Gurley (s), and porosity were measured as described hereinabove, and the results are reported in Table 8 below.

TABLE 8

| | | | Calendered |
|---|---|---|---|
| | | | MD and TD- |
| | Conventional | MD and TD- | stretched |
| | MD-only | Stretched | Multilayer |
| | Multilayer | Multilayer | Membrane |
| Thickness (μm) | 39.7 | 19.8 | 14.2 |
| JIS Gurley(s) | 7383 | 79 | 197 |
| Porosity (%) | 35.7 | 67 | 44 |
| Puncture | 788 | 259 | 369 |
| Strength(gf) | | | |
| MD Tensile | 1879 | 927 | 1350 |
| Strength (kg/cm²) | | | |
| TD Tensile | 144 | 503 | 630 |
| Strength (kg/cm²) | | | |
| MD Elongation (%) | 69 | 144 | 105 |
| TD Elongation (%) | 744 | 119 | 175 |
| MD shrinkage | — | — | 9/15 |
| 105/120 C. | | | |
| TD Shrinkage | — | — | 2/6 |
| 105/120 C. | | | |

### (2) Example with Additional MD-Stretching

### Example 2(a)

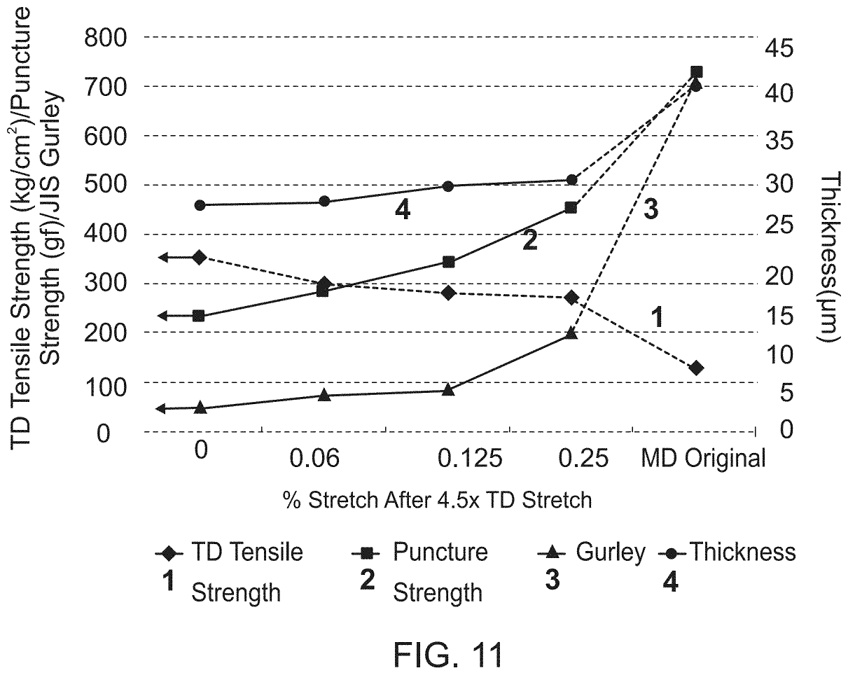

In some Examples, a trilayer non-porous precursor comprising a polypropylene (PP)-containing layer, a polyethylene (PE)-containing layer, and a PP-containing layer, in that order, i.e., a PP/PE/PP trilayer was formed by extruding three layers comprising these polymers, e.g., two PP layers and a single PE layer, without the use of a solvent or oil, and then laminating these layers together to form the PP/PE/PE trilayer nonporous precursor. The PP/PE/PP trilayer nonporous precursor is then MD stretched, followed by TD stretching of 4.5× (450%). Following TD stretching at 4.5×(450%), different samples were subjected to an additional MD stretching of 0.06, 0.125, and 0.25%. The TD tensile strength, puncture strength, JIS Gurley, and thickness of the MD-stretched PP/PE/PP trilayer nonporous precursor, the MD and TD stretched PP/PE/PP trilayer nonporous precursor, and the MD and TD (with additional MD stretching at 0.06, 0.125, and 0.25% were measured and are reported in the graph in FIG. 11.

### (3) Examples with Pore Filling

### Example 3(a)

In some Example, a non-porous polypropylene (PP) monolayer is formed MD stretched, e.g., to form pores, then TD stretched, and then the pores are filled with a pore-filling composition comprising a polyolefin. The thickness, MD tensile strength, TD tensile strength, puncture strength, Gurley (s), and porosity were measured as described hereinabove, and the results are reported in Table 9 below. In Table 9, a conventional MD-only monolayer product is added for comparison. It is the same as in 1 (g) above.

TABLE 9

| | | | MD and TD |
|---|---|---|---|
| | Conventional | MD and TD- | Stretched PP- |
| | MD-only | Stretched PP- | Monolayer with |
| | Monolayer | Monlayer | Filled Pores |
| Thickness (μm) | 12 | 12 | 11 |
| JIS Gurley(s) | 120 | 28 | 220 |
| Porosity (%) | 51 | 68 | 48 |
| Puncture | 220 | 190 | 260 |
| Strength(gf) | | | |
| Puncture | 262 | 301 | 318 |
| Strength (gf) | | | |
| normalized for | | | |
| 14 micron | | | |
| thickness and | | | |
| 50% porosity | | | |
| MD Tensile | 1900 | 900 | 750 |
| Strength (kg/cm²) | | | |
| TD Tensile | 130 | 500 | 750 |
| Strength (kg/cm²) | | | |

In accordance with at least certain embodiments, here are respective TDC examples without and with a pin removal force reducing additive (to lower the pin removal force or COF) and their respective average pin removal force. The results are shown in Table 10 below.

TABLE 10

| | Without pin | With pin |
|---|---|---|
| | removal reducing | removal reducing |
| | additive | additive |
| Average Pin Removal Force (gf) | 289.5 | 80.7 |

As shown in Table 10, the example with a pin removal reducing addiitve has a much reduced pin removal force over the example without a pin removal reducing additive (over a 72% reduction). Microporous polymeric (especially polyolefinic) membranes and separators can be made by various processes, and the process by which the membrane or separator is made has an impact upon the membrane's physical attributes. See, Kesting, R., Synthetic Polymeric Membranes, A structural perspective, Second Edition, John Wiley & Sons, New York, N.Y., (1985) regarding three commercial processes for making microporous membranes: the dry-stretch process (also known as the CELGARD process), the wet process, and the particle stretch process.

The dry-stretch process refers to a process where pore formation results from stretching the nonporous precursor. See, Kesting, Ibid. pages 290-297, incorporated herein by reference. The dry-stretch process is different from the wet process and particle stretch process. Generally, in the wet process, also known as the thermal phase inversion process, or the extraction process or the TIPS process (to name a few), the polymeric raw material is mixed with a processing oil (sometimes referred to as a plasticizer), this mixture is extruded, and pores are then formed when the processing oil is removed (these films may be stretched before or after the removal of the oil). See, Kesting, Ibid. pages 237-286, incorporated herein by reference. Generally, in the particle stretch process, the polymeric raw material is mixed with particulate, this mixture is extruded, and pores are formed during stretching when the interface between the polymer and the particulate fractures due to the stretching forces.

Moreover, the membranes arising from these processes are physically different and the process by which each is made distinguishes one membrane from the other. Dry-MD stretch membranes tend to have slit shaped pores. Wet process membranes tend to have rounder pores due to MD+TD stretching. Particle stretched membranes, on the other hand, tend to have football or eye shaped pores. Accordingly, each membrane may be distinguished from the other by its method of manufacture.

There are other solvent or oil free membrane production processes. One can add wax and/or solvent to the resin mix and burn it off in the oven. Another membrane production process is known as the BOPP or beta nucleated biaxially oriented polypropylene (BNBOPP) production process.

Membrane production processes that produce pore shapes other than slits (that may include TD stretching) may increase the membrane transverse direction tensile strength. For example, U.S. Pat. No. 8,795,565 is directed to a membrane made by a dry-stretch process and that has substantially round shaped pores and includes the steps of: extruding a polymer into a nonporous precursor, and biaxially stretching the nonporous precursor, the biaxial stretching including a machine direction stretching and a transverse direction stretching including a simultaneous controlled machine direction relax. U.S. Pat. No. 8,795,565 granted Aug. 5, 2014 is hereby incorporated by reference herein.

In accordance with at least certain embodiments of the present invention, a dry process production method (with less than 10% oil or solvent, preferably less than 5% oil or solvent) including a transverse direction stretching including a simultaneous controlled machine direction relax with post stretching calendering may be preferred. Such a process may provide a dry-stretch process membrane or separator having enhanced TD strength, reduced thickness, increased pore size, surface roughness of less than 0.5 um, increased tortuosity, better balance of TD/MD tensile strength, and/or the like.

In at least selected embodiments, aspects, or objects, the present application or invention application is directed to new and/or improved microporous membranes, battery separators including said microporous membranes, and/or methods for making new and/or improved microporous membranes and/or battery separators including such microporous membranes. For example, the new and/or improved microporous membranes, and battery separators including such membranes, may have better performance, unique structure, and/or a better balance of desirable properties than prior microporous membranes. Also, the new and/or improved methods produce microporous membranes, thin porous membranes, unique membranes, and/or battery separators including such membranes, having a better performance, unique performance, unique performance for dry process membranes or separators, unique structure, and/or a better balance of desirable properties than prior microporous membranes. The new and/or improved microporous membranes, battery separators including said microporous membranes, and/or methods may address issues, problems, or needs associated with at least certain prior microporous membranes.

In at least selected embodiments, aspects, or objects, the present application or invention application is directed to new and/or improved microporous membranes, battery separators including said microporous membranes, and/or methods for making new and/or improved membranes or separators that may address the issues, problems or needs of prior microporous membranes or separators, and/or may provide new and/or improved microporous membranes, battery separators including said microporous membranes, and/or methods for making new and/or improved microporous membranes and/or battery separators comprising such microporous membranes. For example, the new and/or improved microporous membranes, and battery separators comprising such membranes, may have better performance, unique structure, and/or a better balance of desirable properties than prior microporous membranes. Also, the new and/or improved methods produce microporous membranes, and battery separators comprising such membranes, having a better performance, unique structure, and/or a better balance of desirable properties than prior microporous membranes. The new and/or improved microporous membranes, battery separators including said microporous membranes, and/or methods may address issues, problems, or needs associated with at least certain prior microporous membranes, and may be useful in batteries or capacitors. In at least certain aspects or embodiments, there may be provided unique, improved, better, or stronger dry process membrane products, such as but not limited to unique stretched and/or calendered products having a puncture strength (PS) of >200, >250, >300, or >400 gf, preferably when normalized for thickness and porosity and/or at 12 um or less thickness, more preferably at 10 um or less thickness, a unique pore structure of angled, aligned, oval (for example, in cross-section view SEM), or more polymer, plastic or meat (for example, in surface view SEM), unique characteristics, specs, or performance of porosity, uniformity (std dev), transverse direction (TD) strength, shrinkage (machine direction (MD) or TD), TD stretch %, MD/TD balance, MD/TD tensile strength balance, tortuosity, and/or thickness, unique structures (such as coated, pore filled, monolayer, and/or multi-layer), unique methods, methods of production or use, and combinations thereof.

At least certain embodiments, aspects or objects are directed to methods for making microporous membranes, and battery separators including the same, that have a better balance of desirable properties than prior microporous membranes and battery separators. The methods disclosed herein comprise the following steps: 1.) obtaining a non-porous membrane precursor; 2.) forming a porous biaxially-stretched membrane precursor from the non-porous membrane precursor; 3.) performing at least one of (a) calendering, (b) an additional machine direction (MD) stretching, (c) an additional transverse direction (TD) stretching, (d) a pore-filling, and (e) coating on the porous biaxially stretched precursor to form the final microporous membrane. The microporous membranes or battery separators described herein may have the following desirable balance of properties, prior to application of any coating: a TD tensile strength greater than 200 or greater than 250 kg/cm², a puncture strength greater than 200, 250, 300, or 400 gf, and a JIS Gurley greater than 20 or 50 s.

In accordance with at least selected embodiments, aspects, or objects, the present application or invention may address the above-mentioned issues, problems or needs of prior membranes, separators, and/or microporous membranes, and/or may provide new and/or improved membranes, separators, microporous membranes, battery separators including said microporous membranes, coated separators, base films for coating, and/or methods for making and/or using new and/or improved microporous membranes and/or battery separators including such microporous membranes. For example, the new and/or improved microporous membranes, and battery separators including such membranes, may have better performance, unique structure, and/or a better balance of desirable properties than prior microporous membranes.

Also, the new and/or improved methods produce microporous membranes, thin porous membranes, unique membranes, and/or battery separators including such membranes, having a better performance, unique performance, unique performance for dry process membranes or separators, unique structure, and/or a better balance of desirable properties than prior microporous membranes. The new and/or improved microporous membranes, battery separators including said microporous membranes, and/or methods may address issues, problems, or needs associated with at least certain prior microporous membranes.

In accordance with at least selected embodiments, aspects, or objects, the present application or invention may address the above-mentioned issues, problems or needs of prior membranes, separators, and/or microporous membranes, and/or may provide new and/or improved MD and/or TD stretched and optionally calendered, coated, dipped, and/or pore filled, membranes, separators, base films, microporous membranes, battery separators including said separator, base film or membrane, batteries including said separator, and/or methods for making and/or using such membranes, separators, base films, microporous membranes, battery separators and/or batteries. For example, new and/or improved methods for making microporous membranes, and battery separators including the same, that have a better balance of desirable properties than prior microporous membranes and battery separators. The methods disclosed herein comprise the following steps: 1.) obtaining a non-porous membrane precursor; 2.) forming a porous biaxially-stretched membrane precursor from the non-porous membrane precursor; 3.) performing at least one of (a) calendering, (b) an additional machine direction (MD) stretching, (c) an additional transverse direction (TD) stretching, and (d) a pore-filling on the porous biaxially stretched precursor to form the final microporous membrane. The microporous membranes or battery separators described herein may have the following desirable balance of properties, prior to application of any coating: a TD tensile strength greater than 200 or 250 kg/cm², a puncture strength greater than 200, 250, 300, or 400 gf, and a JIS Gurley greater than 20 or 50 s.

Various embodiments of the present invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1.-107. (canceled)

108. A battery separator comprising a dry process MD stretched and TD stretched and calendered trilayer microporous membrane wherein the three layers are co-extruded in the absence of an oil or solvent, the trilayer microporous membrane comprises a PP layer, a PE layer, and a PP layer, in that order (PP-PE-PP), wherein the PP layers are made from a polypropylene having a molecular weight of at least 450,000, the MD stretched and TD stretched and calendered microporous co-extruded trilayer membrane having each of the following properties, prior to application of any coating to the MD stretched and TD stretched and calendered microporous co-extruded trilayer membrane:
a. a TD tensile strength of from about 450 to about 600 kg/cm²;
b. a puncture strength of between 400 and 700 gf, between 300 and 600 gf, or between 400 and 600; and
c. a JIS Gurley greater than or equal to 20 s, between 50 and 300 s, or between 100 and 300_s; and
wherein the trilayer microporous membrane is coated on at least one side, and the coating optionally comprises a polymer and organic or inorganic particles; and
wherein the trilayer microporous membrane has been calendered to have a thickness of 16 microns or less.

109. The battery separator of claim 108, wherein the thickness of the microporous membrane between 4 and 10 microns.

110. The battery separator of claim 108, wherein the JIS Gurley is between 50 and 300 s.

111. The battery separator of claim 108, wherein the JIS Gurley is between 100 and 300 s.

112. The battery separator of claim 108, wherein the puncture strength is between 300 and 600 gf.

113. The battery separator of claim 110, wherein the puncture strength is between 400 and 700 gf.
